(19) United States
(12) Patent Application Publication
(10) Pub. No.: US 2026/0367356 A1
(43) Pub. Date: Nov. 19, 2026

(54) OPTICAL LENS ASSEMBLY AND ELECTRONIC DEVICE

(71) Applicant: NEWMAX TECHNOLOGY CO., LTD., Taichung City (TW)

(72) Inventors: Ching-Yun HUANG, Taichung City (TW); Fei-Hsin TSAI, Taichung City (TW); Ping-Yi CHEN, Taichung City (TW)

(21) Appl. No.: 19/302,072

(22) Filed: Aug. 17, 2025

(30) Foreign Application Priority Data
May 7, 2025 (TW) 114117123

(51) Int. Cl. G02B 9/16; G02B 1/04; G02B 3/04; G02B 27/01

(52) U.S. Cl. CPC G02B 9/16; G02B 1/041; G02B 3/04; G02B 27/0172; G02B 27/0176; G02B 2027/0152; G02B 2027/0178

(57) ABSTRACT

An optical lens assembly includes: a first lens with positive refractive power, a reflective polarizer, a second lens, a phase retarder, a third lens with positive refractive power and a partial-reflective-partial-transmissive element. The first lens, the reflective polarizer, the second lens, the third lens and the partial-reflective-partial-transmissive element are disposed in order from a visual side to an image source side, the phase retarder is disposed between the reflective polarizer and the partial-reflective-partial-transmissive element. The optical lens assembly may become lightweight and have good image quality when satisfying a specific condition.

### BACKGROUND

### Field of the Invention

The present invention relates to an optical lens assembly and electronic device, and more particularly to an optical lens assembly applicable to electronic devices.

### Description of Related Art

With the development of the semiconductor industry, the functions of various consumer electronic products are increasingly powerful. Moreover, various services of the software application end emerge. These enable consumers to have more choices. Virtual reality (VR) technology emerges when the market is no longer satisfied with handheld electronic products. Nowadays, the application of virtual reality opens up a blue ocean market for consumer electronics, and in the application field of virtual reality, the first commercialized project is the head-mounted display.

However, the current head-mounted displays are heavy and have poor image quality.

The present invention mitigates and/or obviates the aforementioned disadvantages.

### SUMMARY

The objective of the present invention is to provide an optical lens assembly and an electronic device, whereby the number of lenses can be reduced by folding the light path, so as to the reduce the weight of the device, and provide better image quality.

Therefore, an optical lens assembly in accordance with an embodiment of the present invention includes: a first lens with positive refractive power, including a visual-side surface being convex in a paraxial region thereof; a reflective polarizer; a second lens with refractive power; a phase retarder; a third lens with positive refractive power, including an image source-side surface being convex in a paraxial region thereof; and a partial-reflective-partial-transmissive element. The first lens, the reflective polarizer, the second lens, the third lens and the partial-reflective-partial-transmissive element are disposed in order from a visual side to an image source side, and the phase retarder is disposed between the reflective polarizer and the partial-reflective-partial-transmissive element.

Optionally, a thickness of the second lens along an optical axis is CT2, a thickness of the third lens along the optical axis is CT3, an absolute value of a displacement in parallel to the optical axis from an intersection between an image source-side surface of the second lens and the optical axis to a maximum effective radius position on the image source-side surface of the second lens is TDP4, an absolute value of a displacement in parallel to the optical axis from an intersection between the image source-side surface of the third lens and the optical axis to a maximum effective radius position on the image source-side surface of the third lens is TDP6, and the following conditional formula is satisfied: 0.05<TDP4*CT2/(TDP6*CT3)<1.35. This conditional formula is conducive to providing an appropriate space for the arrangement of lenses and achieving better lens manufacturability.

Optionally, a maximum field of view of the optical lens assembly focusing on a far point is FOV_F, a maximum field of view of the optical lens assembly focusing on a near point is FOV_N, a distance from an image source-side surface of the first lens to a visual-side surface of the second lens along the optical axis, when the optical lens assembly focuses on the far point, is T12_F, a distance from the image source-side surface of the first lens to the visual-side surface of the second lens along the optical axis, when the optical lens assembly focuses on the near point, is T12_N, and the following conditional formula is satisfied: −0.86<(FOV_F−FOV_N)/(T12_F−T12_N)<5.33. This conditional formula is conducive to providing a better working space for the movement of the second lens, to meet the focus adjustment range without causing significant variation in the field of view.

Optionally, a focal length of the optical lens assembly focusing on the far point is f_F, a focal length of the optical lens assembly focusing on the near point is f_N, a distance from the image source-side surface of the second lens to a visual-side surface of the third lens along the optical axis, when the optical lens assembly focuses on the far point, is T23_F, a distance from the image source-side surface of the second lens to the visual-side surface of the third lens along the optical axis, when the optical lens assembly focuses on the near point, is T23_N, and the following conditional formula is satisfied: −0.09<(f_F−f_N)/(T23_F−T23_N)<0.59. This conditional formula is conducive to reducing the variation in the focus length upon focus adjustment.

Optionally, the maximum field of view of the optical lens assembly focusing on the far point is FOV_F, a distance from the visual-side surface of the first lens to an image plane along the optical axis is TL, a maximum image height of the optical lens assembly is IMH, and the following conditional formula is satisfied: 0.09<FOV_F/(TL*IMH)<0.63. This conditional formula is conducive to achieving a compact size of the optical lens assembly by this better ratio between the field of view and the product of the length of the optical lens assembly and the image height arising from the display.

Optionally, a thickness of the first lens along the optical axis is CT1, the thickness of the second lens along the optical axis is CT2, and the following conditional formula is satisfied: 0.54<CT1/CT2<3.11. This conditional formula is conducive to ensuring the imaging quality and better lens manufacturability through a better ratio of thicknesses of lenses.

Optionally, the thickness of the second lens along the optical axis is CT2, the thickness of the third lens along the optical axis is CT3, and the following conditional formula is satisfied: 0.61<CT3/CT2<4.19. This conditional formula is conducive to ensuring the imaging quality and better lens manufacturability through a better ratio of thicknesses of lenses.

Optionally, a maximum effective radius of the image source-side surface of the third lens is CA6, the maximum image height of the optical lens assembly is IMH, and the following conditional formula is satisfied: 0.8<CA6/IMH<1.95. This conditional formula is conducive to appropriately changing the lens surface profile to achieve a much narrower incident angle of light.

Optionally, a maximum effective radius of the visual-side surface of the first lens is CA1, the maximum effective radius of the image source-side surface of the third lens is CA6, and the following conditional formula is satisfied: 0.48<CA1/CA6<0.91. This conditional formula is conducive to ensuring the stability of assembling of lenses through this more appropriate ratio between the effective radius of the largest lens and the effective radius of the smallest lens.

Optionally, the distance from the image source-side surface of the first lens to the visual-side surface of the second lens along the optical axis, when the optical lens assembly focuses on the far point, is T12_F, the distance from the image source-side surface of the second lens to the visual-side surface of the third lens along the optical axis, when the optical lens assembly focuses on the far point, is T23_F, the absolute value of the displacement in parallel to the optical axis from the intersection between the image source-side surface of the second lens and the optical axis to the maximum effective radius position on the image source-side surface of the second lens is TDP4, and the following conditional formula is satisfied: 0.52<(T12_F+T23_F)/TDP4<54.9. This conditional formula is conducive to achieving a proper ratio between the available range of focus adjustment and the depth of the image source-side portion of the second lens while the length of the optical lens assembly is minimized as far as possible.

Optionally, the distance from the visual-side surface of the first lens to the image plane along the optical axis is TL, the thickness of the first lens along the optical axis is CT1, the thickness of the third lens along the optical axis is CT3, and the following conditional formula is satisfied: 0.4 mm⁻¹<TL/(CT1*CT3)<2.73 mm⁻¹. This conditional formula is conducive to properly balancing the thicknesses of lenses and the length of the optical lens assembly to minimize the space for the optical lens assembly as far as possible.

Optionally, the thickness of the third lens along the optical axis is CT3, the absolute value of the displacement in parallel to the optical axis from the intersection between the image source-side surface of the third lens and the optical axis to the maximum effective radius position on the image source-side surface of the third lens is TDP6, the maximum effective radius of the image source-side surface of the third lens is CA6, and the following conditional formula is satisfied: 0.14 mm<CT3*TDP6/CA6<1.42 mm. This conditional formula is conducive to achieving a proper shape ratio of the third lens to ensure that the lens shaping meets the processing requirements of the manufacturing process.

Optionally, the maximum image height of the optical lens assembly is IMH, the focal length of the optical lens assembly focusing on the far point is f_F, the focal length of the optical lens assembly focusing on the near point is f_N, and the following conditional formula is satisfied: 10.16<IMH/|(f_F−f_N)|<126.53. This conditional formula is conducive to achieving the proper difference between the focus lengths of the optical lens assembly focusing on the far and near points, under the image height corresponding to the field of view causing the beast imaging quality.

Optionally, a radius of curvature of the visual-side surface of the first lens is R1, the thickness of the first lens along the optical axis is CT1, the maximum effective radius of the visual-side surface of the first lens is CA1, and the following conditional formula is satisfied: 5.46<R1*CT1/CA1<35.19. This conditional formula is conducive to achieving a proper shape ratio of the first lens to ensure that the lens shaping meets the processing requirements of the manufacturing process.

Optionally, a radius of curvature of the image source-side surface of the third lens is R6, the maximum effective radius of the image source-side surface of the third lens is CA6, and the following conditional formula is satisfied: −6.57<R6/CA6<−2.16. This conditional formula is conducive to achieving the more appropriate refractive power of the third lens through this ratio.

Optionally, a focal length of the first lens is f1, a focal length of the third lens is f3, and the following conditional formula is satisfied: 0.55<f1/f3<9.61. This conditional formula is conducive to properly balancing the refractive power of the first lens and the refractive power of the third lens to stabilizing the variation of distortion caused by focus adjustment.

Optionally, the distance from the visual-side surface of the first lens to the image plane along the optical axis is TL, the maximum image height of the optical lens assembly is IMH, and the following conditional formula is satisfied: 0.79<TL/IMH<1.55. This conditional formula is conducive to more appropriately balancing the height of the optical lens assembly and the size of the display.

Optionally, at least one of the visual-side surfaces of the second lens and the visual-side surface of the third lens is flat in a paraxial region thereof.

Optionally, the total number of lenses with refractive power is three in the optical lens assembly.

Optionally, when the optical lens assembly focuses on the near point, the second lens is closer to the third lens but farther from the first lens; and when the optical lens assembly focuses on the far point, the second lens is closer to the first lens but farther from the third lens.

Moreover, an electronic device in accordance with an embodiment of the present invention includes a housing, the aforementioned optical lens assembly disposed in the housing, an image source disposed on the image source plane of the optical lens assembly in the housing, and a controller disposed in the housing and electrically connected to the image source.

### BRIEF DESCRIPTION OF THE DRAWINGS

The present invention will be presented in further details from the following descriptions with the accompanying drawings, which show, for purpose of illustrations only, the preferred embodiments in accordance with the present invention:

FIG. 1A is a schematic diagram of an optical lens assembly focusing on a near point in accordance with a second embodiment of the present invention;

FIG. 1B is a schematic diagram of the optical lens assembly focusing on a far point in accordance with the second embodiment of the present invention;

FIG. 1C is a partial amplified diagram of the optical lens assembly of FIG. 1A;

FIG. 1D is a partial amplified diagram of the optical lens assembly of FIG. 1B;

FIG. 2A is a schematic diagram of an optical lens assembly focusing on a near point in accordance with a third embodiment of the present invention;

FIG. 2B is a schematic diagram of the optical lens assembly focusing on a far point in accordance with the third embodiment of the present invention;

FIG. 3A is a schematic diagram of an optical lens assembly focusing on a near point in accordance with a fourth embodiment of the present invention;

FIG. 3B is a schematic diagram of the optical lens assembly focusing on a far point in accordance with the fourth embodiment of the present invention;

FIG. 4A is a schematic diagram of an optical lens assembly focusing on a near point in accordance with a fifth embodiment of the present invention;

FIG. 4B is a schematic diagram of the optical lens assembly focusing on a far point in accordance with the fifth embodiment of the present invention;

FIG. 5A is a schematic diagram of an optical lens assembly focusing on a near point in accordance with a sixth embodiment of the present invention;

FIG. 5B is a schematic diagram of the optical lens assembly focusing on a far point in accordance with the sixth embodiment of the present invention;

FIG. 6A is a schematic diagram of an optical lens assembly focusing on a near point in accordance with a seventh embodiment of the present invention;

FIG. 6B is a schematic diagram of the optical lens assembly focusing on a far point in accordance with the seventh embodiment of the present invention;

FIG. 7A is a schematic diagram of an optical lens assembly focusing on a near point in accordance with an eighth embodiment of the present invention;

FIG. 7B is a schematic diagram of the optical lens assembly focusing on a far point in accordance with the eighth embodiment of the present invention;

FIG. 8A is a schematic diagram of an optical lens assembly focusing on a near point in accordance with a ninth embodiment of the present invention;

FIG. 8B is a schematic diagram of the optical lens assembly focusing on a far point in accordance with the ninth embodiment of the present invention;

FIG. 9A is a schematic diagram of an optical lens assembly focusing on a near point in accordance with a tenth embodiment of the present invention;

FIG. 9B is a schematic diagram of the optical lens assembly focusing on a far point in accordance with the tenth embodiment of the present invention;

FIG. 10 is a schematic diagram of an electronic device in accordance with an embodiment of the present invention.

### DETAILED DESCRIPTION

### First Embodiment

An optical lens assembly in accordance with a first embodiment of the present invention includes: a first lens with positive refractive power, including a visual-side surface being convex in a paraxial region thereof; a reflective polarizer; a second lens with refractive power; a phase retarder (that is, a first phase retarder); a third lens with positive refractive power, including an image source-side surface being convex in a paraxial region thereof; and a partial-reflective-partial-transmissive element. The first lens, the reflective polarizer, the second lens, the third lens and the partial-reflective-partial-transmissive element are disposed in order from a visual side to an image source side, and the phase retarder is disposed between the reflective polarizer and the partial-reflective-partial-transmissive element.

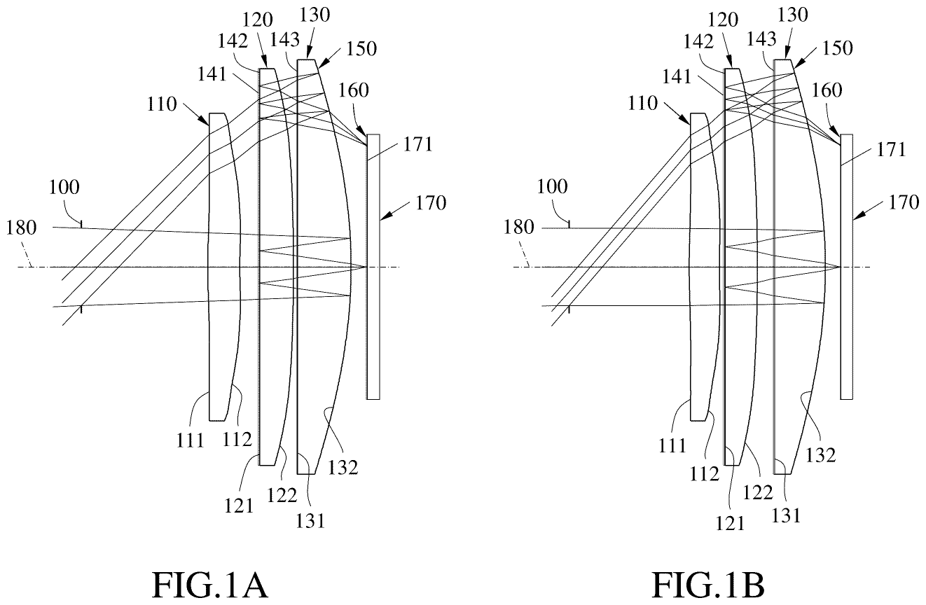

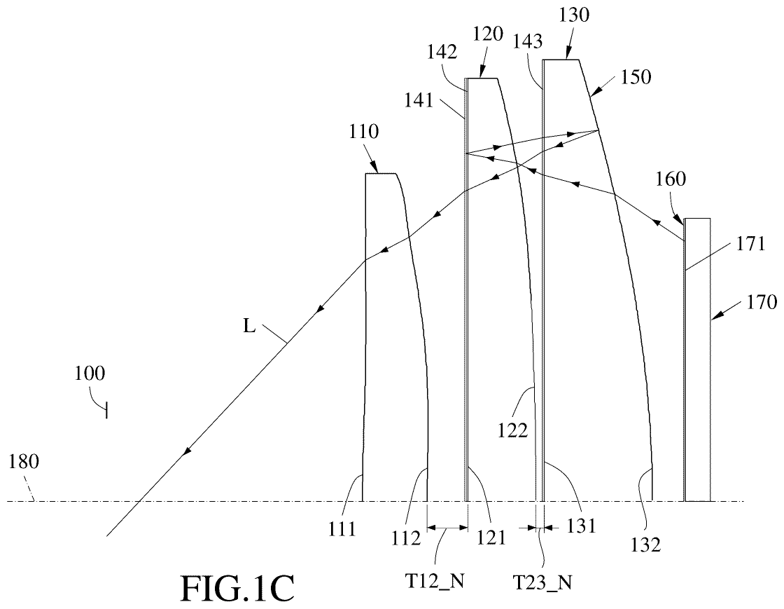

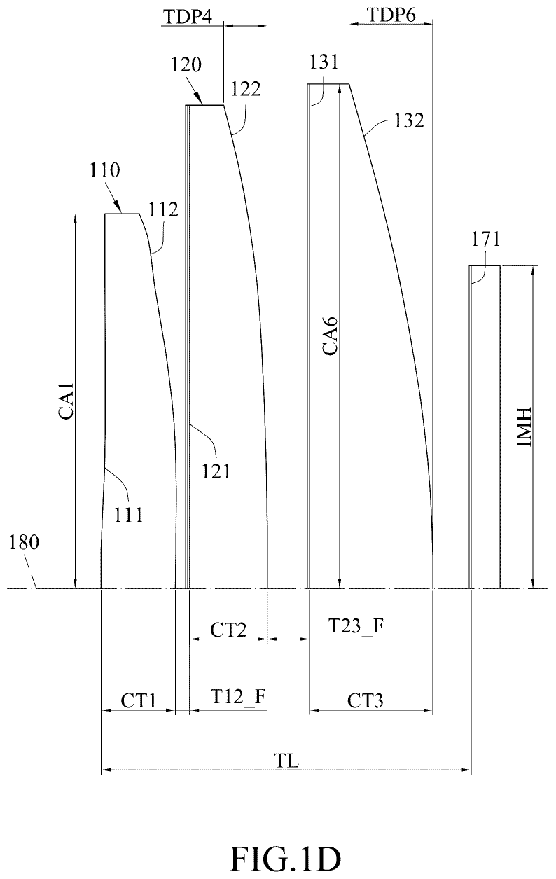

In the optical lens assembly, as shown in FIGS. 1C and 1D, a thickness of a first lens 110 along an optical axis 180 is CT1, a thickness of a second lens 120 along the optical axis 180 is CT2, a thickness of a third lens 130 along the optical axis 180 is CT3, an absolute value of a displacement in parallel to the optical axis 180 from an intersection between an image source-side surface 122 of the second lens 120 and the optical axis 180 to a maximum effective radius position on the image source-side surface 122 of the second lens 120 is TDP4, an absolute value of a displacement in parallel to the optical axis 180 from an intersection between an image source-side surface 132 of the third lens 130 and the optical axis 180 to a maximum effective radius position on the image source-side surface 132 of the third lens 130 is TDP6, a maximum field of view of the optical lens assembly focusing on a far point is FOV_F, a maximum field of view of the optical lens assembly focusing on a near point is FOV_N, a distance from an image source-side surface 112 of the first lens 110 to a visual-side surface 121 of the second lens 120 along the optical axis 180, when the optical lens assembly focuses on the far point, is T12_F, a distance from the image source-side surface 112 of the first lens 110 to the visual-side surface 121 of the second lens 120 along the optical axis 180, when the optical lens assembly focuses on the near point, is T12_N, a focal length of the optical lens assembly focusing on the far point is f_F, a focal length of the optical lens assembly focusing on the near point is f_N, a distance from the image source-side surface 122 of the second lens 120 to a visual-side surface 131 of the third lens 130 along the optical axis 180, when the optical lens assembly focuses on the far point, is T23_F, a distance from the image source-side surface 122 of the second lens 120 to the visual-side surface 131 of the third lens 130 along the optical axis 180, when the optical lens assembly focuses on the near point, is T23_N, a distance from a visual-side surface 111 of the first lens 110 to an image plane 171 along the optical axis 180 is TL, a maximum image height of the optical lens assembly is IMH, a maximum effective radius of the visual-side surface 111 of the first lens 110 is CA1, a maximum effective radius of the image source-side surface 132 of the third lens 130 is CA6, a radius of curvature of the visual-side surface 111 of the first lens 110 is R1, a radius of curvature of the image source-side surface 132 of the third lens 130 is R6, a focal length of the first lens 110 is f1, a focal length of the third lens 130 is f3, and at least one of the following conditional formulas is satisfied:

0.05<TDP4*CT2/(TDP6*CT3)<1.35;

−0.86<(FOV_F−FOV_N)/(T12_F−T12_N)<5.33;

−0.09<(f_F−f_N)/(T23_F−T23_N)<0.59;

0.09<FOV_F/(TL*IMH)<0.63;

0.54<CT1/CT2<3.11;

0.61<CT3/CT2<4.19;

0.8<CA6/IMH<1.95;

0.48<CA1/CA6<0.91;

0.52<(T12_F+T23_F)/TDP4<54.9;

0.4 mm⁻¹<TL/(CT1*CT3)<2.73 mm⁻¹;

0.14 mm<CT3*TDP6/CA6<1.42 mm;

10.16<IMH/|(f_F−f_N)|<126.53;

5.46<R1*CT1/CA1<35.19;

−6.57<R6/CA6<−2.16;

0.55<f1/f3<9.61; and

0.79<TL/IMH<1.55.

### Second Embodiment

Referring to FIGS. 1A-1D, an optical lens assembly in accordance with a second embodiment of the present invention includes, in order from a visual side to an image source side along an optical axis 180: a stop 100, a first lens 110, an absorptive polarizer 141, a reflective polarizer 142, a second lens 120, a first phase retarder 143, a third lens 130, a partial-reflective-partial-transmissive element 150, a second phase retarder 160 and an image source plane 171. The optical lens assembly has, for example, but not limited to, a total of three lenses with refractive power. When the optical lens assembly focuses on a near point, the second lens 120 is closer to the third lens 130 but farther from the first lens 110; and when the optical lens assembly focuses on a far point, the second lens 120 is closer to the first lens 110 but farther from the third lens 130.

The stop 100 may be located in a position where the user's eyes are located for viewing an image.

The first lens 110 with positive refractive power includes a visual-side surface 111 and an image source-side 112, the visual-side surface 111 of the first lens 110 is convex in a paraxial region thereof, the image source-side surface 112 of the first lens 110 is concave in a paraxial region thereof, the visual-side surface 111 and the image source-side surface 112 of the first lens 110 are aspheric, and the first lens 110 is made of plastic.

The second lens 120 with positive refractive power includes a visual-side surface 121 and an image source-side surface 122, the visual-side surface 121 of the second lens 120 is flat in a paraxial region thereof, the image source-side surface 122 of the second lens 120 is convex in a paraxial region thereof, the image source-side surface 122 of the second lens 120 is aspheric, and the second lens 120 is made of plastic.

The third lens 130 with positive refractive power includes a visual-side surface 131 and an image source-side surface 132, the visual-side surface 131 of the third lens 130 is flat in a paraxial region thereof, the image source-side surface 132 of the third lens 130 is convex in a paraxial region thereof, the image source-side surface 132 of the third lens 130 is aspheric, and the third lens 130 is made of plastic.

A visual-side surface of the absorptive polarizer 141 faces the first lens 110, an image source-side surface of the absorptive polarizer 141 is jointed with a visual-side surface of the reflective polarizer 142, an image source-side surface of the reflective polarizer 142 is jointed with the visual-side surface 121 of the second lens 120.

A visual-side surface of the first phase retarder 143 faces the second lens 120, and an image source-side surface of the first phase retarder 143 is jointed with the visual-side surface 131 of the third lens 130. The first phase retarder 143 is, for example, but not limited to, a quarter-wave plate.

A visual-side surface of the partial-reflective-partial-transmissive element 150 is jointed with the image source-side surface 132 of the third lens 130 and has an average reflectance of at least 30%, preferably 50%, with respect to the wavelength band of visible light. The average reflectance here is an average value of different reflectance of the partial-reflective-partial-transmissive element 150 for different wavelengths.

A visual-side surface of the second phase retarder 160 faces the partial-reflective-partial-transmissive element 150, and an image source-side surface of the second phase retarder 160 is jointed with the image plane 171. The second phase retarder 160 is, for example, but not limited to, a quarter-wave plate.

The optical lens assembly works in cooperation with an image source 170 disposed on the image source plane 171 located between second phase retarder 160 and the image source 170. In the present embodiment, the type of the image source 170 is, for example, but not limited to, an OLED display, a LED display, a liquid crystal display, or other displays.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:
z represents the value of a reference position at a height of h with respect to a vertex of the surface of a lens along the optical axis 180;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 180;
k represents the conic constant; and
Ai represents the i-th order aspheric coefficient.

The optical lens assembly of the first embodiment utilizes the configuration and arrangement of the absorptive polarizer, the reflective polarizer, the phase retarders, the partial-reflective-partial-transmissive element and the lenses to fold the light path thereof by the transmission and reflection of light to shorten the length of the optical lens assembly required for forming an image without affecting the image quality.

In a light path L in FIG. 1C, a linearly-polarized beam from the image source plane 171 becomes a circularly-polarized beam after passing through the second phase retarder 160, and then, this circularly-polarized beam travels onto the partial-reflective-partial-transmissive element 150. The circularly-polarized beam traveling onto the partial-reflective-partial-transmissive element 150 has a component passing through the partial-reflective-partial-transmissive element 150, the third lens 130 and the first phase retarder 143 to form a linearly-polarized light component, and then, this linearly-polarized light component travels to and passes through the second lens 120, the first phase retarder 143 and the third lens 130 to turn into a circularly-polarized light component. This circularly-polarized light component travels onto the partial-reflective-partial-transmissive element 150, and a part of the circularly-polarized light component is reflected as linearly-polarized image light by the partial-reflective-partial-transmissive element 150 and then passes through the third lens 130, the first phase retarder 143, the second lens 120, the reflective polarizer 142, the absorptive polarizer 141 and the first lens 110. Finally, the linearly-polarized image light transmits to the user's eyes, so as to form an image visually.

Please refer to Tables 1-4, Table 1 shows the detailed optical data of the elements of the optical lens assembly of the second embodiment, Table 2 shows the aspheric coefficients of the aspherical surfaces of the elements of the optical lens assembly of the second embodiment, Table 3 shows the remaining parameters of the optical lens assembly of the second embodiment and the values thereof, and the values of the parameters in Tables 1 and 3 meet the conditional formulas of Table 4. An entrance pupil diameter of the optical lens assembly is EPD, a focal length of the second lens 120 is f2, a focal length of the third lens 130 is f3, the remaining parameters may be defined by the first embodiment and will not be provided again.

TABLE 1
f_F = 16.36 mm, f_N = 15.84 mm, EPD = 8.00 mm,
FOV_F = 100.4°, FOV_N = 95.3°

| | | | | | Abbe | |
|---|---|---|---|---|---|---|
| Surface | | Radius of | | Refractive | number | Refraction/ |
| # | | curvature | Thickness/gap | index (nd) | (vd) | reflection |
| 0 | Stop | Infinity | 12.000 | — | — | — |
| 1 | First lens | 63.87 | 3.051 | 1.544 | 55.9 | Refraction |
| 2 | | 115.88 | 0.403(Far point) | — | — | Refraction |
| | | | 1.728(Near | | | |
| | | | point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 3.197 | 1.544 | 55.9 | Refraction |
| 6 | | −254.20 | 1.625(Far point) | — | — | Refraction |
| | | | 0.300(Near | | | |
| | | | point) | | | |
| 7 | First phase | Infinity | 0.100 | 1.544 | 55.9 | Refraction |
| | retarder | | | | | |
| 8 | Third lens | Infinity | 5.085 | 1.544 | 55.9 | Refraction |
| 9 | Partial- | −56.37 | 0.000 | Mirror | | Reflection |
| | reflective- | | | | | |
| | partial- | | | | | |
| | transmissive | | | | | |
| | element | | | | | |
| 10 | Third lens | −56.37 | −5.085 | 1.544 | 55.9 | Refraction |
| 11 | First phase | Infinity | −0.100 | 1.533 | 56.0 | Refraction |
| | retarder | | | | | |
| 12 | | Infinity | −1.625(Far | — | — | Refraction |
| | | | point) | | | |
| | | | −0.300(Near | | | |
| | | | point) | | | |
| 13 | Second lens | −254.20 | −3.197 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 3.197 | 1.544 | 55.9 | Refraction |
| 17 | | −254.20 | 1.625(Far point) | — | — | Refraction |
| | | | 0.300(Near | | | |
| | | | point) | | | |
| 18 | First phase | Infinity | 0.100 | 1.533 | 56.0 | Refraction |
| | retarder | | | | | |
| 19 | Third lens | Infinity | 5.085 | 1.544 | 55.9 | Refraction |
| 20 | | −56.37 | 1.525 | — | — | Refraction |
| 21 | Second phase | Infinity | 0.100 | 1.533 | 56.0 | Refraction |
| | retarder | | | | | |
| 22 | Image source | Infinity | — | — | — | — |
| | plane | | | | | |

The reference wavelength is 555 nm.

TABLE 2

| Surface | 1 | 2 | 5, 14, 16 |
|---|---|---|---|
| K: | 1.4346E+01 | 5.0295E+01 | 0.0000E+00 |
| A2: | 0.0000E+00 | 0.0000E+00 | 0.0000E+00 |
| A4: | −1.7179E−04 | −1.8706E−04 | 0.0000E+00 |
| A6: | 2.0994E−06 | 1.7776E−06 | 0.0000E+00 |
| A8: | −1.7099E−08 | −1.2015E−08 | 0.0000E+00 |
| A10: | 7.5473E−11 | 4.7774E−11 | 0.0000E+00 |
| A12: | −1.3600E−13 | −7.8008E−14 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |
| Surface | 6, 13, 17 | 8, 11, 19 | 9, 20 |
| K: | −9.0000E+01 | 0.0000E+00 | −1.5789E+00 |
| A2: | 0.0000E+00 | 0.0000E+00 | 0.0000E+00 |
| A4: | −8.8114E−06 | 0.0000E+00 | 5.9959E−06 |
| A6: | 8.4221E−08 | 0.0000E+00 | −2.8471E−08 |
| A8: | −5.6924E−10 | 0.0000E+00 | 1.0335E−10 |
| A10: | 1.4371E−12 | 0.0000E+00 | −1.8603E−13 |
| A12: | −1.2467E−15 | 0.0000E+00 | 1.2911E−16 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 3

| | | | | | | | |
|---|---|---|---|---|---|---|---|
| f1 | 254.52 | T12_F | 0.40 | T23_N | 0.30 | CA1 | 13.47 |
| f2 | 464.07 | T12_N | 1.73 | CT3 | 5.08 | CA6 | 19.93 |
| f3 | 102.92 | CT2 | 3.20 | TL | 15.29 | TDP4 | 1.42 |
| CT1 | 3.05 | T23_F | 1.62 | IMH | 12.56 | TDP6 | 3.06 |

All units are mm (millimetre)

TABLE 4

| | | | | | |
|---|---|---|---|---|---|
| (FOV_F-FOV_N)/(T12_F-T12_N) | 3.84 | TDP4*CT2/(TDP6*CT3) | 0.29 | R1*CT1/CA1 [mm] | 14.47 |
| (f_F-f_N)/(T23_F-T23_N) | 0.39 | CA1/CA6 | 0.68 | R6/CA6 | −2.83 |
| FOV_F/(TL*IMH) [°/mm\hat{ }2] | 0.53 | (T12_F + T23_F)/TDP4 | 1.43 | f1/f3 | 2.47 |
| CT1/CT2 | 0.95 | TL/(CT1*CT3) [mm\hat{ }-1] | 0.99 | TL/IMH | 1.22 |
| CT3/CT2 | 1.59 | CT3*TDP6/CA6 [mm] | 0.78 | — | — |
| CA6/IMH | 1.59 | IMH/\| (f_F-f_N) \| | 24.39 | — | — |

In Table 1, the units of the radius of curvature, the thickness, the gap and the focal length are expressed in mm, and the surface numbers 22-0 respectively represent the surfaces through which the light sequentially transmits from the image source plane 171 to the stop 100 along the light path L, wherein the surface 0 represents a gap between the stop 100 (or the user's eyes) and the first lens 110 along the optical axis 180; the surface 1 represents the thickness of the first lens 110 along the optical axis 180; the surface 2 represents a gap between the first lens 110 and the absorptive polarizer 141 along the optical axis 180; the surface 3 represents the thickness of the absorptive polarizer 141 along the optical axis 180; the surfaces 4, 14 and 15 represent the thickness of the reflective polarizer 142 along the optical axis 180; the surfaces 5, 13 and 16 represent the thickness of the second lens 120 along the optical axis 180; the surfaces 6, 12 and 17 represent a gap between the second lens 120 and the first phase retarder 143 along the optical axis 180; the surfaces 7, 11 and 18 represent the thickness of the first phase retarder 143 along the optical axis 180; the surfaces 8, 10 and 19 represent the thickness of the third lens 130 along the optical axis 180; the surface 9 represents the thickness of the reflective-partial-transmissive element 150 along the optical axis 180; the surface 20 represents a gap between the third lens 130 and the second phase retarder 160 along the optical axis 180; and the surface 16 represents the thickness of the second phase retarder 160 along the optical axis 180. The gaps and thicknesses having a positive sign in Table 1 denote the transmission direction of light is toward the stop 100, and the gaps and thicknesses having a negative sign in Table 1 denote the transmission direction of light is toward the image source plane 171.

In Table 2, k represents the conic constant of the equation of aspheric surface profiles, and A2, A4, A6, A8, A10, A12, A14, A16, A18, and A20 represent the high-order aspheric coefficients.

The respective tables presented below for the third to tenth embodiments are based on the schematic view of this embodiment, and the definitions of parameters in the tables are the same as those in the first embodiment and Tables 1-4 of the second embodiment. Therefore, an explanation in this regard will not be provided again.

### Third Embodiment

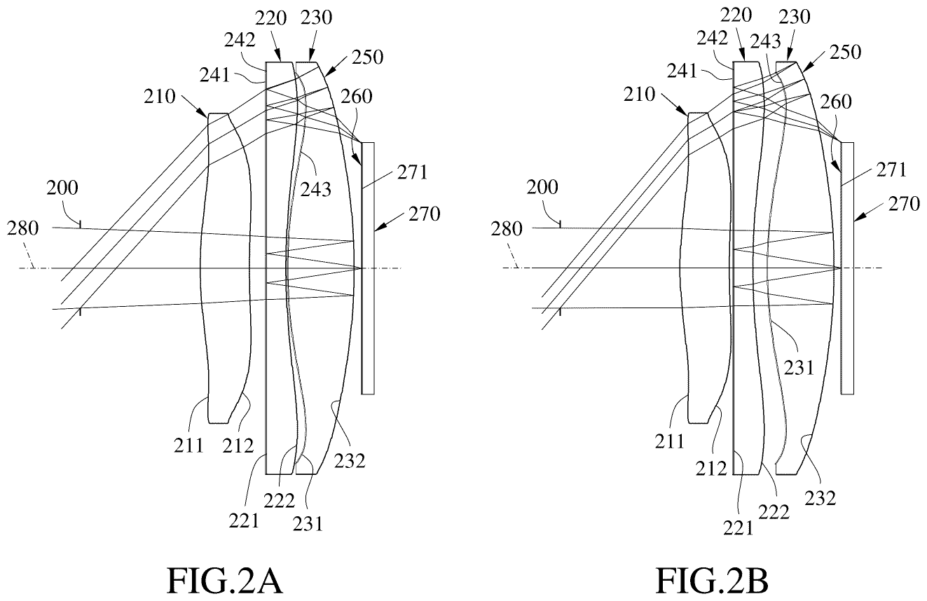

Referring to FIGS. 2A and 2B, an optical lens assembly in accordance with a third embodiment of the present invention includes, in order from a visual side to an image source side along an optical axis 280: a stop 200, a first lens 210, an absorptive polarizer 241, a reflective polarizer 242, a second lens 220, a first phase retarder 243, a third lens 230, a partial-reflective-partial-transmissive element 250, a second phase retarder 260 and an image source plane 271. The optical lens assembly has, for example, but not limited to, a total of three lenses with refractive power. When the optical lens assembly focuses on a near point, the second lens 220 is closer to the third lens 230 but farther from the first lens 210; and when the optical lens assembly focuses on a far point, the second lens 220 is closer to the first lens 210 but farther from the third lens 230.

The configurations of the stop 200, the absorptive polarizer 241, the reflective polarizer 242, the first phase retarder 243, the partial-reflective-partial-transmissive element 250, the second phase retarder 260 and the image source plane 271 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 270 in cooperation with the optical lens assembly may refer to that of the second embodiment and will not be explained again.

The first lens 210 with positive refractive power includes a visual-side surface 211 and an image source-side 212, the visual-side surface 211 of the first lens 210 is convex in a paraxial region thereof, the image source-side surface 212 of the first lens 210 is concave in a paraxial region thereof, the visual-side surface 211 and the image source-side surface 212 of the first lens 210 are aspheric, and the first lens 210 is made of plastic.

The second lens 220 with negative refractive power includes a visual-side surface 221 and an image source-side surface 222, the visual-side surface 221 of the second lens 220 is flat in a paraxial region thereof, the image source-side surface 222 of the second lens 220 is concave in a paraxial region thereof, the image source-side surface 222 of the second lens 220 is aspheric, and the second lens 220 is made of plastic.

The third lens 230 with positive refractive power includes a visual-side surface 231 and an image source-side surface 232, the visual-side surface 231 of the third lens 230 is convex in a paraxial region thereof, the image source-side surface 232 of the third lens 230 is convex in a paraxial region thereof, the visual-side surface 231 and the image source-side surface 232 of the third lens 230 are aspheric, and the third lens 230 is made of plastic.

Please refer to Tables 5-8, Table 5 shows the detailed optical data of the elements of the optical lens assembly of the third embodiment, Table 6 shows the aspheric coefficients of the aspherical surfaces of the elements of the optical lens assembly of the third embodiment, Table 7 shows the remaining parameters of the optical lens assembly of the third embodiment and the values thereof, and the values of the parameters in Tables 5 and 7 meet the conditional formulas of Table 8. In the third embodiment, the equation of the aspheric surface profiles of the aforementioned lenses is the same as the equation of the aspheric surface profiles of the aforementioned lenses in the second embodiment. The parameters and the definitions of the surfaces in Tables of the third embodiment are the same as those of Tables of the second embodiment and will not be explained again.

TABLE 5
f_F = 16.15 mm, f_N = 15.84 mm, EPD = 8.00 mm,
FOV_F = 100.3°, FOV_N = 95.3°

| | | | | | Abbe | |
|---|---|---|---|---|---|---|
| Surface | | Radius of | Thickness/ | Refractive | number | Refraction/ |
| # | | curvature | gap | index (nd) | (vd) | reflection |
| 0 | Stop | Infinity | 12.000 | — | — | — |
| 1 | First lens | 38.09 | 4.929 | 1.544 | 55.9 | Refraction |
| 2 | | 75.83 | 0.300(Far point) | — | — | Refraction |
| | | | 1.589(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 1.900 | 1.648 | 23.3 | Refraction |
| 6 | | 71.03 | 1.389(Far point) | — | — | Refraction |
| | | | 0.100(Near point) | | | |
| 7 | First phase | 44.575 | 0.100 | 1.544 | 55.9 | Refraction |
| | retarder | | | | | |
| 8 | Third lens | 44.575 | 6.636 | 1.544 | 55.9 | Refraction |
| 9 | Partial- | −58.25 | 0.000 | Mirror | | Reflection |
| | reflective- | | | | | |
| | partial- | | | | | |
| | transmissive | | | | | |
| | element | | | | | |
| 10 | Third lens | −58.25 | −6.636 | 1.544 | 55.9 | Refraction |
| 11 | First phase | 44.575 | −0.100 | 1.533 | 56.0 | Refraction |
| | retarder | | | | | |
| 12 | | 44.575 | −1.389(Far point) | — | — | Refraction |
| | | | −0.100(Near point) | | | |
| 13 | Second lens | 71.03 | −1.900 | 1.648 | 23.3 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 1.900 | 1.648 | 23.3 | Refraction |
| 17 | | 71.03 | 1.389(Far point) | — | — | Refraction |
| | | | 0.100(Near point) | | | |
| 18 | First phase | 44.575 | 0.100 | 1.533 | 56.0 | Refraction |
| | retarder | | | | | |
| 19 | Third lens | 44.575 | 6.636 | 1.544 | 55.9 | Refraction |
| 20 | | −58.25 | 0.632 | | | Refraction |
| 21 | Second phase | Infinity | 0.100 | 1.533 | 56.0 | Refraction |
| | retarder | | | | | |
| 22 | Image source | Infinity | — | — | — | — |
| | plane | | | | | |

The reference wavelength is 550 nm.

TABLE 6
Aspheric Coefficients

| Surface | 1 | 2 | 5, 14, 16 |
|---|---|---|---|
| K: | −1.2836E+01 | 0.0000E+00 | 0.0000E+00 |
| A2: | 0.0000E+00 | 0.0000E+00 | 0.0000E+00 |
| A4: | −2.1183E−05 | −6.9181E−05 | 0.0000E+00 |
| A6: | −9.1864E−08 | −2.6548E−08 | 0.0000E+00 |
| A8: | −1.4550E−10 | −1.8069E−11 | 0.0000E+00 |
| A10: | 8.5697E−13 | −3.0954E−13 | 0.0000E+00 |
| A12: | 4.2156E−15 | 6.3086E−16 | 0.0000E+00 |
| A14: | 6.3926E−18 | 8.1474E−18 | 0.0000E+00 |
| A16: | −2.2509E−20 | 3.5905E−20 | 0.0000E+00 |
| A18: | 0.0000E+00 | 0.0000E+00 | 0.0000E+00 |
| A20: | 0.0000E+00 | 0.0000E+00 | 0.0000E+00 |
| Surface | 6, 13, 17 | 8, 11, 19 | 9, 20 |
| K: | −3.1953E+00 | −1.7482E+00 | −2.1523E+00 |
| A2: | 0.0000E+00 | 0.0000E+00 | 0.0000E+00 |
| A4: | −2.9911E−06 | −7.2793E−06 | 2.7069E−06 |
| A6: | −2.0499E−08 | −2.1105E−08 | 6.7700E−09 |
| A8: | −3.0284E−11 | −1.3174E−11 | −2.2303E−11 |
| A10: | 1.4288E−14 | −3.6296E−14 | −3.4909E−14 |
| A12: | 1.2434E−16 | 7.4157E−19 | −4.7691E−17 |
| A14: | 1.8958E−19 | −2.1689E−20 | −1.6260E−20 |
| A16: | −5.3641E−22 | −9.9997E−22 | 2.5068E−22 |
| A18: | 0.0000E+00 | 0.0000E+00 | 0.0000E+00 |
| A20: | 0.0000E+00 | 0.0000E+00 | 0.0000E+00 |

TABLE 7

| | | | | | | | |
|---|---|---|---|---|---|---|---|
| f1 | 133.55 | T12_F | 0.30 | T23_N | 0.10 | CA1 | 14.11 |
| f2 | −109.59 | T12_N | 1.59 | CT3 | 6.64 | CA6 | 20.31 |
| f3 | 106.34 | CT2 | 1.90 | TL | 16.19 | TDP4 | 0.98 |
| CT1 | 4.93 | T23_F | 1.39 | IMH | 12.56 | TDP6 | 3.61 |

All units are mm (millimetre)

TABLE 8

| | | | | | |
|---|---|---|---|---|---|
| (FOV_F − FOV_N)/ | 3.88 | TDP4*CT2/ | 0.08 | R1*CT1/CA1 | 13.31 |
| (T12_F − T12_N) | | (TDP6*CT3) | | [mm] | |
| (f_F − f_N)/ | 0.24 | CA1/CA6 | 0.69 | R6/CA6 | −2.87 |
| (T23_F − T23_N) | | | | | |
| FOV_F/(TL*IMH) | 0.49 | (T12_F + T23_F)/ | 1.72 | f1/f3 | 1.26 |
| [°/mm\hat{ }2] | | TDP4 | | | |
| CT1/CT2 | 2.59 | TL/(CT1*CT3) | 0.49 | TL/IMH | 1.29 |
| | | [mm\hat{ }−1] | | | |
| CT3/CT2 | 3.49 | CT3*TDP6/CA6 | 1.18 | — | — |
| | | [mm] | | | |
| CA6/IMH | 1.62 | IMH/\| (f_F − f_N) \| | 40.80 | — | — |

### Fourth Embodiment

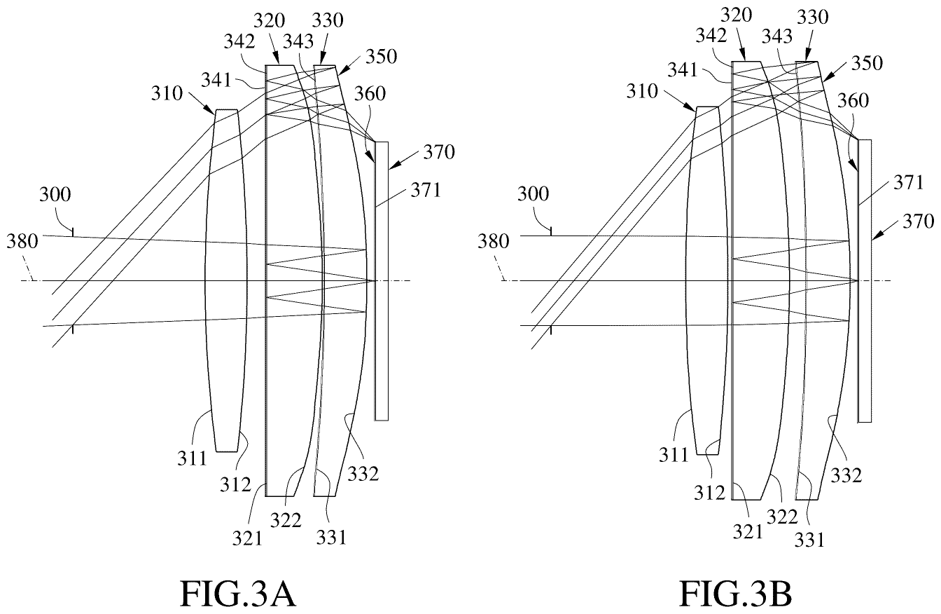

Referring to FIGS. 3A and 3B, an optical lens assembly in accordance with a fourth embodiment of the present invention includes, in order from a visual side to an image source side along an optical axis 380: a stop 300, a first lens 310, an absorptive polarizer 341, a reflective polarizer 342, a second lens 320, a first phase retarder 343, a third lens 330, a partial-reflective-partial-transmissive element 350, a second phase retarder 360 and an image source plane 371.

The optical lens assembly has, for example, but not limited to, a total of three lenses with refractive power. When the optical lens assembly focuses on a near point, the second lens 320 is closer to the third lens 330 but farther from the first lens 310; and when the optical lens assembly focuses on a far point, the second lens 320 is closer to the first lens 310 but farther from the third lens 330.

The configurations of the stop 300, the absorptive polarizer 341, the reflective polarizer 342, the first phase retarder 343, the partial-reflective-partial-transmissive element 350, the second phase retarder 360 and the image source plane 371 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 370 in cooperation with the optical lens assembly may refer to that of the second embodiment and will not be explained again.

The first lens 310 with positive refractive power includes a visual-side surface 311 and an image source-side 312, the visual-side surface 311 of the first lens 310 is convex in a paraxial region thereof, the image source-side surface 312 of the first lens 310 is convex in a paraxial region thereof, the visual-side surface 311 and the image source-side surface 312 of the first lens 310 are aspheric, and the first lens 310 is made of plastic.

The second lens 320 with positive refractive power includes a visual-side surface 321 and an image source-side surface 322, the visual-side surface 321 of the second lens 320 is flat in a paraxial region thereof, the image source-side surface 322 of the second lens 320 is convex in a paraxial region thereof, the image source-side surface 322 of the second lens 320 is aspheric, and the second lens 320 is made of plastic.

The third lens 330 with positive refractive power includes a visual-side surface 331 and an image source-side surface 332, the visual-side surface 331 of the third lens 330 is concave in a paraxial region thereof, the image source-side surface 332 of the third lens 330 is convex in a paraxial region thereof, the visual-side surface 331 of the third lens 330 is spherical, the image source-side surface 332 of the third lens 330 is aspheric, and the third lens 330 is made of plastic.

Please refer to Tables 9-12, Table 9 shows the detailed optical data of the elements of the optical lens assembly of the fourth embodiment, Table 10 shows the aspheric coefficients of the aspherical surfaces of the elements of the optical lens assembly of the fourth embodiment, Table 11 shows the remaining parameters of the optical lens assembly of the fourth embodiment and the values thereof, and the values of the parameters in Tables 9 and 11 meet the conditional formulas of Table 12. In the fourth embodiment, the equation of the aspheric surface profiles of the aforementioned lenses is the same as the equation of the aspheric surface profiles of the aforementioned lenses in the second embodiment. The parameters and the definitions of the surfaces in Tables of the fourth embodiment are the same as those of Tables of the second embodiment and will not be explained again.

TABLE 9
f_F = 16.63 mm, f_N = 16.03 mm, EPD = 8.00 mm, FOV_F = 100.3°, FOV_N = 94.4°

| Surface | | Reflective | Thickness/ | Refractive | Abbe | Refraction/ |
|---|---|---|---|---|---|---|
| # | | polarizer | gap | index (nd) | number (vd) | reflection |
| 0 | Stop | Infinity | 12.000 | — | — | — |
| 1 | First lens | 120.18 | 3.786 | 1.544 | 55.9 | Refraction |
| 2 | | −139.65 | 0.300(Far point) | — | — | Refraction |
| | | | 1.627(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 5.047 | 1.544 | 55.9 | Refraction |
| 6 | | −73.64 | 1.427(Far point) | — | — | Refraction |
| | | | 0.100(Near point) | | | |
| 7 | First phase | −201.702 | 0.100 | 1.544 | 55.9 | Refraction |
| | retarder | | | | | |
| 8 | Third lens | −201.702 | 3.859 | 1.544 | 55.9 | Refraction |
| 9 | Partial- | −66.63 | 0.000 | Mirror | | Reflection |
| | reflective- | | | | | |
| | partial- | | | | | |
| | transmissive | | | | | |
| | element | | | | | |
| 10 | Third lens | −66.63 | −3.859 | 1.544 | 55.9 | Refraction |
| 11 | First phase | −201.702 | −0.100 | 1.533 | 56.0 | Refraction |
| | retarder | | | | | |
| 12 | | −201.702 | −1.427(Far point) | — | — | Refraction |
| | | | −0.100(Near point) | | | |
| 13 | Second lens | −73.64 | −5.047 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 5.047 | 1.544 | 55.9 | Refraction |
| 17 | | −73.64 | 1.427(Far point) | — | — | Refraction |
| | | | 0.100(Near point) | | | |
| 18 | First phase | −201.702 | 0.100 | 1.533 | 56.0 | Refraction |
| | retarder | | | | | |
| 19 | Third lens | −201.702 | 3.859 | 1.544 | 55.9 | Refraction |
| 20 | | −66.63 | 0.699 | — | — | Refraction |
| 21 | Second phase | Infinity | 0.100 | 1.533 | 56.0 | Refraction |
| | retarder | | | | | |
| 22 | Image source | Infinity | — | — | — | — |
| | plane | | | | | |

The reference wavelength is 550 nm.

TABLE 10
Aspheric Coefficients

| Surface | 1 | 2 | 5, 14, 16 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 0.0000E+00 | 0.0000E+00 | 0.0000E+00 |
| A6: | 0.0000E+00 | 0.0000E+00 | 0.0000E+00 |
| A8: | 0.0000E+00 | 0.0000E+00 | 0.0000E+00 |
| A10: | 0.0000E+00 | 0.0000E+00 | 0.0000E+00 |
| A12: | 0.0000E+00 | 0.0000E+00 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |
| Surface | 6, 13, 17 | 8, 11, 19 | 9, 20 |
| K: | 0.0000E+00 | 0.0000E+00 | 7.6919E+00 |
| A2: | 0.0000E+00 | 0.0000E+00 | 0.0000E+00 |
| A4: | 1.7573E−05 | 0.0000E+00 | −1.3650E−06 |
| A6: | −3.5659E−08 | 0.0000E+00 | 1.1888E−08 |
| A8: | −4.5198E−11 | 0.0000E+00 | 8.3412E−12 |
| A10: | −3.5901E−14 | 0.0000E+00 | 2.7290E−14 |
| A12: | −5.0751E−17 | 0.0000E+00 | 3.8546E−17 |
| A14: | 2.8967E−19 | 0.0000E+00 | −7.9244E−21 |
| A16: | 1.1576E−21 | 0.0000E+00 | −1.2189E−22 |
| A18: | 0.0000E+00 | 0.0000E+00 | 0.0000E+00 |
| A20: | 0.0000E+00 | 0.0000E+00 | 0.0000E+00 |

TABLE 11

| | | | | | | | |
|---|---|---|---|---|---|---|---|
| f1 | 118.53 | T12_F | 0.30 | T23_N | 0.10 | CA1 | 15.52 |
| f2 | 134.44 | T12_N | 1.63 | CT3 | 3.86 | CA6 | 20.37 |
| f3 | 121.64 | CT2 | 5.05 | TL | 15.52 | TDP4 | 2.64 |
| CT1 | 3.79 | T23_F | 1.43 | IMH | 12.56 | TDP6 | 3.07 |

All units are mm (millimetre)

TABLE 12

| | | | | | |
|---|---|---|---|---|---|
| (FOV_F − FOV_N)/ | 4.44 | TDP4*CT2/ | 1.12 | R1*CT1/CA1 | 29.32 |
| (T12_F − T12_N) | | (TDP6*CT3) | | [mm] | |
| (f_F − f_N)/ | 0.46 | CA1/CA6 | 0.76 | R6/CA6 | −3.27 |
| (T23_F − T23_N) | | | | | |
| FOV_F/(TL*IMH) | 0.52 | (T12_F + T23_F)/ | 0.65 | f1/f3 | 0.97 |
| [°/mm\hat{ }2] | | TDP4 | | | |
| CT1/CT2 | 0.75 | TL/(CT1*CT3) | 1.06 | TL/IMH | 1.24 |
| | | [mm\hat{ }−1] | | | |
| CT3/CT2 | 0.76 | CT3*TDP6/CA6 | 0.58 | — | — |
| | | [mm] | | | |
| CA6/IMH | 1.62 | IMH/\| (f_F − f_N) \| | 20.78 | — | — |

### Fifth Embodiment

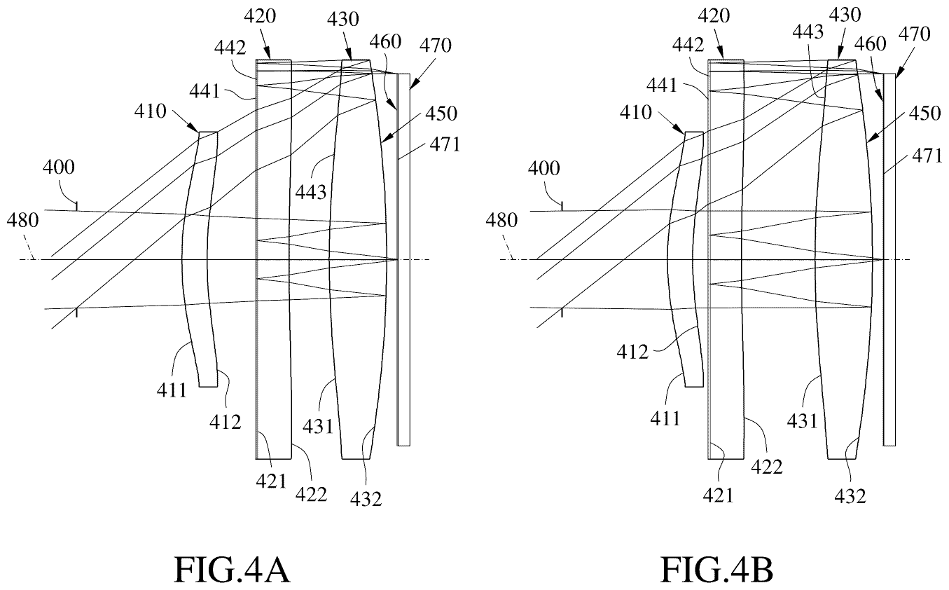

Referring to FIGS. 4A and 4B, an optical lens assembly in accordance with a fifth embodiment of the present invention includes, in order from a visual side to an image source side along an optical axis 480: a stop 400, a first lens 410, an absorptive polarizer 441, a reflective polarizer 442, a second lens 420, a first phase retarder 443, a third lens 430, a partial-reflective-partial-transmissive element 450, a second phase retarder 460 and an image source plane 471.

The optical lens assembly has, for example, but not limited to, a total of three lenses with refractive power. When the optical lens assembly focuses on a near point, the second lens 420 is closer to the third lens 430 but farther from the first lens 410; and when the optical lens assembly focuses on a far point, the second lens 420 is closer to the first lens 410 but farther from the third lens 430.

The configurations of the stop 400, the absorptive polarizer 441, the reflective polarizer 442, the first phase retarder 443, the partial-reflective-partial-transmissive element 450, the second phase retarder 460 and the image source plane 471 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 470 in cooperation with the optical lens assembly may refer to that of the second embodiment and will not be explained again.

The first lens 410 with positive refractive power includes a visual-side surface 411 and an image source-side 412, the visual-side surface 411 of the first lens 410 is convex in a paraxial region thereof, the image source-side surface 412 of the first lens 410 is concave in a paraxial region thereof, the visual-side surface 411 and the image source-side surface 412 of the first lens 410 are spherical, and the first lens 410 is made of plastic.

The second lens 420 with negative refractive power includes a visual-side surface 421 and an image source-side surface 422, the visual-side surface 421 of the second lens 420 is flat in a paraxial region thereof, the image source-side surface 422 of the second lens 420 is concave in a paraxial region thereof, the image source-side surface 422 of the second lens 420 is aspheric, and the second lens 420 is made of plastic.

The third lens 430 with positive refractive power includes a visual-side surface 431 and an image source-side surface 432, the visual-side surface 431 of the third lens 430 is convex in a paraxial region thereof, the image source-side surface 432 of the third lens 430 is convex in a paraxial region thereof, the visual-side surface 431 and the image source-side surface 432 of the third lens 430 are aspheric, and the third lens 430 is made of plastic.

Please refer to Tables 13-16, Table 13 shows the detailed optical data of the elements of the optical lens assembly of the fifth embodiment, Table 14 shows the aspheric coefficients of the aspherical surfaces of the elements of the optical lens assembly of the fifth embodiment, Table 15 shows the remaining parameters of the optical lens assembly of the fifth embodiment and the values thereof, and the values of the parameters in Tables 13 and 15 meet the conditional formulas of Table 16. In the fifth embodiment, the equation of the aspheric surface profiles of the aforementioned lenses is the same as the equation of the aspheric surface profiles of the aforementioned lenses in the second embodiment. The parameters and the definitions of the surfaces in Tables of the fifth embodiment are the same as those of Tables of the second embodiment and will not be explained again.

TABLE 13
f_F = 34.64 mm, f_N = 33.03 mm, EPD = 12.00 mm, FOV_F = 76.9°, FOV_N = 78.6°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 13.045 | — | — | — |
| 1 | First lens | 35.57 | 3.122 | 1.544 | 55.9 | Refraction |
| 2 | | 44.54 | 1.894(Far point) | — | — | Refraction |
| | | | 6.001(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 3.874 | 1.544 | 55.9 | Refraction |
| 6 | | 313.30 | 9.081(Far point) | — | — | Refraction |
| | | | 4.974(Near point) | | | |
| 7 | First phase | 123.961 | 0.100 | 1.544 | 55.9 | Refraction |
| | retarder | | | | | |
| 8 | Third lens | 123.961 | 7.005 | 1.544 | 55.9 | Refraction |
| 9 | Partial- | −136.43 | 0.000 | Mirror | | Reflection |
| | reflective- | | | | | |
| | partial- | | | | | |
| | transmissive | | | | | |
| | element | | | | | |
| 10 | Third lens | −136.43 | −7.005 | 1.544 | 55.9 | Refraction |
| 11 | First phase | 123.961 | −0.100 | 1.533 | 56.0 | Refraction |
| | retarder | | | | | |
| 12 | | 123.961 | −9.081(Far point) | — | — | Refraction |
| | | | −4.974(Near point) | | | |
| 13 | Second lens | 313.30 | −3.874 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 3.874 | 1.544 | 55.9 | Refraction |
| 17 | | 313.30 | 9.081(Far point) | — | — | Refraction |
| | | | 4.974(Near point) | | | |
| 18 | First phase | 123.961 | 0.100 | 1.533 | 56.0 | Refraction |
| | retarder | | | | | |
| 19 | Third lens | 123.961 | 7.005 | 1.544 | 55.9 | Refraction |
| 20 | | −136.43 | 1.316 | — | — | Refraction |
| 21 | Second | Infinity | 0.100 | 1.533 | 56.0 | Refraction |
| | phase | | | | | |
| | retarder | | | | | |
| 22 | Image source | Infinity | — | — | — | — |
| | plane | | | | | |

The reference wavelength is 550 nm.

TABLE 14
Aspheric Coefficients

| Surface | 1 | 2 | 5, 14, 16 |
|---|---|---|---|
| K: | −1.2802E+01 | −2.2123E+01 | 0.0000E+00 |
| A2: | 0.0000E+00 | 0.0000E+00 | 0.0000E+00 |
| A4: | 4.7282E−07 | −5.4478E−06 | 0.0000E+00 |
| A6: | −2.8390E−09 | −7.5855E−09 | 0.0000E+00 |
| A8: | −2.7245E−11 | −5.1936E−12 | 0.0000E+00 |
| A10: | −6.8244E−14 | −4.0079E−14 | 0.0000E+00 |
| A12: | −1.5000E−16 | −2.0383E−16 | 0.0000E+00 |
| A14: | −5.7777E−19 | −6.6816E−19 | 0.0000E+00 |
| A16: | −3.2002E−21 | −1.5981E−21 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | 8.9551E+01 | −1.0000E+00 | −8.5811E+00 |
| A2: | 0.0000E+00 | 0.0000E+00 | 0.0000E+00 |
| A4: | −3.6975E−06 | −2.3702E−06 | 2.1369E−07 |
| A6: | 3.0590E−09 | −2.1479E−10 | −5.8917E−10 |
| A8: | −2.2794E−13 | −1.2327E−13 | 2.1944E−13 |
| A10: | −3.7183E−15 | 4.4298E−16 | 3.6401E−16 |
| A12: | 5.1977E−19 | 7.0542E−19 | 3.5054E−19 |
| A14: | 3.1317E−21 | 1.5299E−22 | 6.9377E−24 |
| A16: | −1.6768E−24 | −1.2964E−24 | −1.7566E−25 |
| A18: | 0.0000E+00 | 0.0000E+00 | 0.0000E+00 |
| A20: | 0.0000E+00 | 0.0000E+00 | 0.0000E+00 |

TABLE 15

| | | | | | | | |
|---|---|---|---|---|---|---|---|
| f1 | 287.68 | T12_F | 1.89 | T23_N | 4.97 | CA1 | 15.43 |
| f2 | −572.82 | T12_N | 6.00 | CT3 | 7.01 | CA6 | 24.93 |
| f3 | 236.54 | CT2 | 3.87 | TL | 26.69 | TDP4 | 0.24 |
| CT1 | 3.12 | T23_F | 9.08 | IMH | 23.00 | TDP6 | 2.13 |

All units are mm (millimetre)

TABLE 16

| | | | | | |
|---|---|---|---|---|---|
| (FOV_F − FOV_N)/ | −0.41 | TDP4*CT2/ | 0.06 | R1*CT1/CA1 | 7.19 |
| (T12_F − T12_N) | | (TDP6*CT3) | | [mm] | |
| (f_F − f_N)/ | 0.39 | CA1/CA6 | 0.62 | R6/CA6 | −5.47 |
| (T23_F − T23_N) | | | | | |
| FOV_F/(TL*IMH) | 0.13 | (T12_F + T23_F)/ | 45.75 | f1/f3 | 1.22 |
| [°/mm\hat{ }2] | | TDP4 | | | |
| CT1/CT2 | 0.81 | TL/(CT1*CT3) | 1.22 | TL/IMH | 1.16 |
| | | [mm\hat{ }−1] | | | |
| CT3/CT2 | 1.81 | CT3*TDP6/CA6 | 0.60 | — | — |
| | | [mm] | | | |
| CA6/IMH | 1.08 | IMH/\| (f_F − f_N) \| | 14.27 | — | — |

### Sixth Embodiment

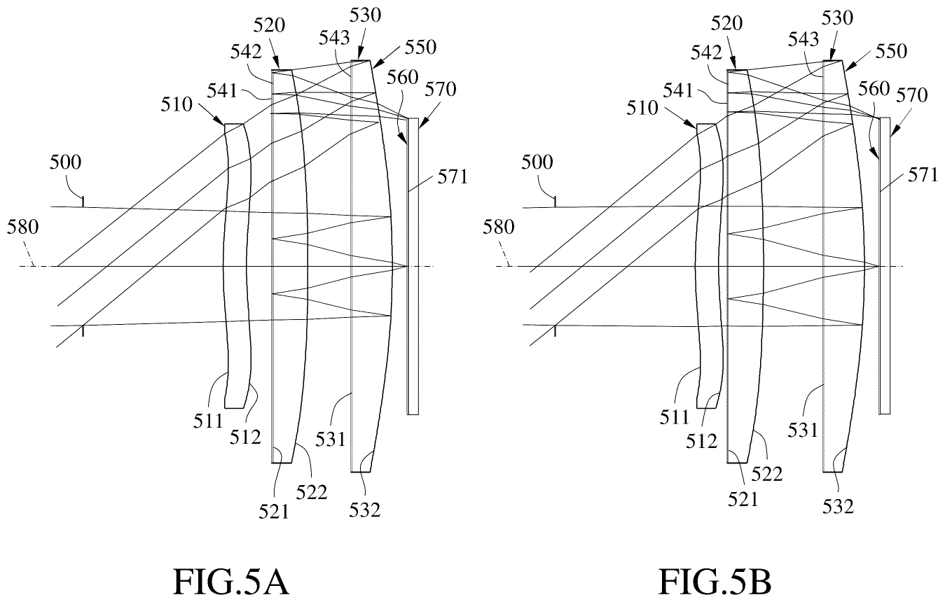

Referring to FIGS. 5A and 5B, an optical lens assembly in accordance with a sixth embodiment of the present invention includes, in order from a visual side to an image source side along an optical axis 580: a stop 500, a first lens 510, an absorptive polarizer 541, a reflective polarizer 542, a second lens 520, a first phase retarder 543, a third lens 530, a partial-reflective-partial-transmissive element 550, a second phase retarder 560 and an image source plane 571.

The optical lens assembly has, for example, but not limited to, a total of three lenses with refractive power. When the optical lens assembly focuses on a near point, the second lens 520 is closer to the third lens 530 but farther from the first lens 510; and when the optical lens assembly focuses on a far point, the second lens 520 is closer to the first lens 510 but farther from the third lens 530.

The configurations of the stop 500, the absorptive polarizer 541, the reflective polarizer 542, the first phase retarder 543, the partial-reflective-partial-transmissive element 550, the second phase retarder 560 and the image source plane 571 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 570 in cooperation with the optical lens assembly may refer to that of the second embodiment and will not be explained again.

The first lens 510 with positive refractive power includes a visual-side surface 511 and an image source-side 512, the visual-side surface 511 of the first lens 510 is convex in a paraxial region thereof, the image source-side surface 512 of the first lens 510 is concave in a paraxial region thereof, the visual-side surface 511 and the image source-side surface 512 of the first lens 510 are aspheric, and the first lens 510 is made of plastic.

The second lens 520 with positive refractive power includes a visual-side surface 521 and an image source-side surface 522, the visual-side surface 521 of the second lens 520 is flat in a paraxial region thereof, the image source-side surface 522 of the second lens 520 is convex in a paraxial region thereof, the image source-side surface 522 of the second lens 520 is aspheric, and the second lens 520 is made of plastic.

The third lens 530 with positive refractive power includes a visual-side surface 531 and an image source-side surface 532, the visual-side surface 531 of the third lens 530 is flat in a paraxial region thereof, the image source-side surface 532 of the third lens 530 is convex in a paraxial region thereof, the image source-side surface 532 of the third lens 530 is aspheric, and the third lens 530 is made of plastic.

Please refer to Tables 17-20, Table 17 shows the detailed optical data of the elements of the optical lens assembly of the sixth embodiment, Table 18 shows the aspheric coefficients of the aspherical surfaces of the elements of the optical lens assembly of the sixth embodiment, Table 19 shows the remaining parameters of the optical lens assembly of the sixth embodiment and the values thereof, and the values of the parameters in Tables 17 and 19 meet the conditional formulas of Table 20. In the sixth embodiment, the equation of the aspheric surface profiles of the aforementioned lenses is the same as the equation of the aspheric surface profiles of the aforementioned lenses in the second embodiment. The parameters and the definitions of the surfaces in Tables of the sixth embodiment are the same as those of Tables of the second embodiment and will not be explained again.

TABLE 17
f_F = 19.63 mm, f_N = 18.94 mm, EPD = 10.00 mm, FOV_F = 78.2°, FOV_N = 77.4°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 12.000 | — | — | — |
| 1 | First lens | 38.26 | 2.000 | 1.544 | 55.9 | Refraction |
| 2 | | 40.31 | 0.678(Far point) | — | — | Refraction |
| | | | 2.095(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 2.970 | 1.544 | 55.9 | Refraction |
| 6 | | −135.41 | 5.058(Far point) | — | — | Refraction |
| | | | 3.641(Near point) | | | |
| 7 | First phase | Infinity | 0.100 | 1.544 | 55.9 | Refraction |
| | retarder | | | | | |
| 8 | Third lens | Infinity | 3.479 | 1.544 | 55.9 | Refraction |
| 9 | Partial- | −69.93 | 0.000 | Mirror | | Reflection |
| | reflective- | | | | | |
| | partial- | | | | | |
| | transmissive | | | | | |
| | element | | | | | |
| 10 | Third lens | -69.93 | −3.479 | 1.544 | 55.9 | Refraction |
| 11 | First phase | Infinity | −0.100 | 1.533 | 56.0 | Refraction |
| | retarder | | | | | |
| 12 | | Infinity | −5.058(Far point) | — | — | Refraction |
| | | | −3.641(Near point) | | | |
| 13 | Second lens | −135.41 | −2.970 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 2.970 | 1.544 | 55.9 | Refraction |
| 17 | | −135.41 | 5.058(Far point) | — | — | Refraction |
| | | | 3.641(Near point) | | | |
| 18 | First phase | Infinity | 0.100 | 1.533 | 56.0 | Refraction |
| | retarder | | | | | |
| 19 | Third lens | Infinity | 3.479 | 1.544 | 55.9 | Refraction |
| 20 | | −69.93 | 1.221 | — | — | Refraction |
| 21 | Second | Infinity | 0.100 | 1.533 | 56.0 | Refraction |
| | phase | | | | | |
| | retarder | | | | | |
| 22 | Image source | Infinity | — | — | — | — |
| | plane | | | | | |

The reference wavelength is 550 nm.

TABLE 18
Aspheric Coefficients

| Surface | 1 | 2 | 5, 14, 16 |
|---|---|---|---|
| K: | 6.9321E+00 | 7.6713E+00 | 0.0000E+00 |
| A2: | 0.0000E+00 | 0.0000E+00 | 0.0000E+00 |
| A4: | −1.1631E−04 | −1.1429E−04 | 0.0000E+00 |
| A6: | −2.7243E−07 | −3.1871E−07 | 0.0000E+00 |
| A8: | 6.8864E−09 | 5.6566E−09 | 0.0000E+00 |
| A10: | −7.0420E−11 | −4.6652E−11 | 0.0000E+00 |
| A12: | 2.3183E−13 | 1.2603E−13 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | 1.2047E+01 | 0.0000E+00 | −1.1090E−01 |
| A2: | 0.0000E+00 | 0.0000E+00 | 0.0000E+00 |
| A4: | 1.0553E−06 | 0.0000E+00 | 1.3906E−06 |
| A6: | −3.2638E−08 | 0.0000E+00 | 5.7472E−09 |
| A8: | −7.2052E−12 | 0.0000E+00 | 2.7845E−11 |
| A10: | 2.0412E−13 | 0.0000E+00 | −8.9011E−14 |
| A12: | 0.0000E+00 | 0.0000E+00 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 19

| | | | | | | | |
|---|---|---|---|---|---|---|---|
| f1 | 1022.76 | T12_F | 0.68 | T23_N | 3.64 | CA1 | 11.20 |
| f2 | 247.21 | T12_N | 2.10 | CT3 | 3.48 | CA6 | 18.50 |
| f3 | 127.66 | CT2 | 2.97 | TL | 15.81 | TDP4 | 1.41 |
| CT1 | 2.00 | T23_F | 5.06 | IMH | 12.56 | TDP6 | 1.92 |

All units are mm (millimetre)

TABLE 20

| | | | | | |
|---|---|---|---|---|---|
| (FOV_F − FOV_N)/ | 0.52 | TDP4*CT2/ | 0.63 | R1*CT1/CA1 | 6.83 |
| (T12_F − T12_N) | | (TDP6*CT3) | | [mm] | |
| (f_F − f_N)/ | 0.49 | CA1/CA6 | 0.61 | R6/CA6 | −3.78 |
| (T23_F − T23_N) | | | | | |
| FOV_F/(TL*IMH) | 0.39 | (T12_F + T23_F)/ | 4.06 | f1/f3 | 8.01 |
| [°/mm\hat{ }2] | | TDP4 | | | |
| CT1/CT2 | 0.67 | TL/(CT1*CT3) | 2.27 | TL/IMH | 1.26 |
| | | [mm\hat{ }−1] | | | |
| CT3/CT2 | 1.17 | CT3*TDP6/CA6 | 0.36 | — | — |
| | | [mm] | | | |
| CA6/IMH | 1.47 | IMH/\| (f_F − f_N) \| | 18.13 | — | — |

### Seventh Embodiment

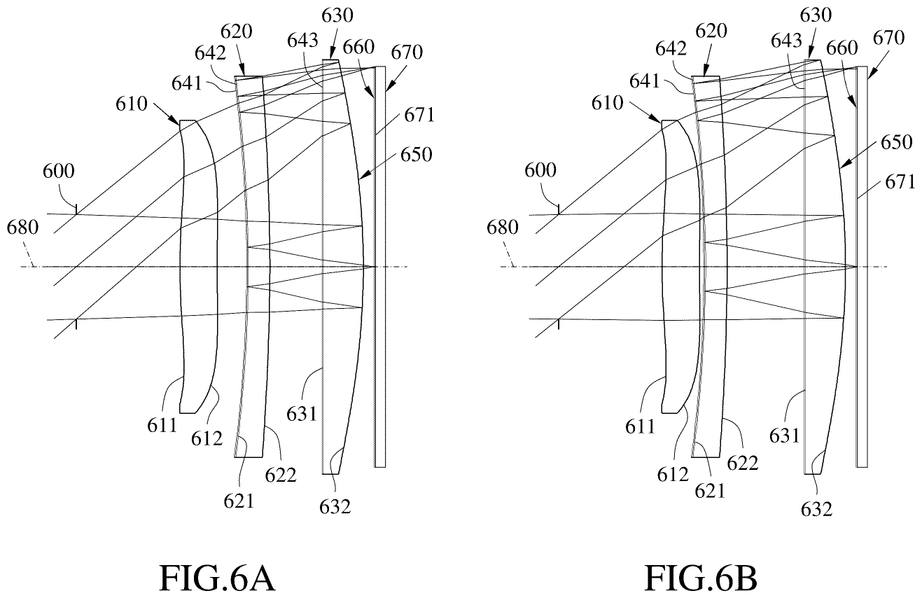

Referring to FIGS. 6A and 6B, an optical lens assembly in accordance with a seventh embodiment of the present invention includes, in order from a visual side to an image source side along an optical axis 680: a stop 600, a first lens 610, an absorptive polarizer 641, a reflective polarizer 642, a second lens 620, a first phase retarder 643, a third lens 630, a partial-reflective-partial-transmissive element 650, a second phase retarder 660 and an image source plane 671.

The optical lens assembly has, for example, but not limited to, a total of three lenses with refractive power. When the optical lens assembly focuses on a near point, the second lens 620 is closer to the third lens 630 but farther from the first lens 610; and when the optical lens assembly focuses on a far point, the second lens 620 is closer to the first lens 610 but farther from the third lens 630.

The configurations of the stop 600, the absorptive polarizer 641, the reflective polarizer 642, the first phase retarder 643, the partial-reflective-partial-transmissive element 650, the second phase retarder 660 and the image source plane 671 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 670 in cooperation with the optical lens assembly may refer to that of the second embodiment and will not be explained again.

The first lens 610 with positive refractive power includes a visual-side surface 611 and an image source-side 612, the visual-side surface 611 of the first lens 610 is convex in a paraxial region thereof, the image source-side surface 612 of the first lens 610 is concave in a paraxial region thereof, the visual-side surface 611 and the image source-side surface 612 of the first lens 610 are aspheric, and the first lens 610 is made of plastic.

The second lens 620 with positive refractive power includes a visual-side surface 621 and an image source-side surface 622, the visual-side surface 621 of the second lens 620 is concave in a paraxial region thereof, the image source-side surface 622 of the second lens 620 is convex in a paraxial region thereof, the visual-side surface 621 of the second lens 620 is spherical, the image source-side surface 622 of the second lens 620 is aspheric, and the second lens 620 is made of plastic.

The third lens 630 with positive refractive power includes a visual-side surface 631 and an image source-side surface 632, the visual-side surface 631 of the third lens 630 is flat in a paraxial region thereof, the image source-side surface 632 of the third lens 630 is convex in a paraxial region thereof, the image source-side surface 632 of the third lens 630 is aspheric, and the third lens 630 is made of plastic.

Please refer to Tables 21-24, Table 21 shows the detailed optical data of the elements of the optical lens assembly of the seventh embodiment, Table 22 shows the aspheric coefficients of the aspherical surfaces of the elements of the optical lens assembly of the seventh embodiment, Table 23 shows the remaining parameters of the optical lens assembly of the seventh embodiment and the values thereof, and the values of the parameters in Tables 21 and 23 meet the conditional formulas of Table 24. In the seventh embodiment, the equation of the aspheric surface profiles of the aforementioned lenses is the same as the equation of the aspheric surface profiles of the aforementioned lenses in the second embodiment. The parameters and the definitions of the surfaces in Tables of the seventh embodiment are the same as those of Tables of the second embodiment and will not be explained again.

TABLE 21
f_F = 32.15 mm, f_N = 32.37 mm, EPD = 12.00 mm, FOV_F = 77.8°, FOV_N = 79.5°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 12.000 | — | — | |
| 1 | First lens | 73.57 | 4.330 | 1.544 | 55.9 | Refraction |
| 2 | | 218.48 | 0.517(Far point) | — | — | Refraction |
| | | | 3.400(Near point) | | | |
| 3 | Absorptive | −166.091 | 0.100 | 1.533 | 56.0 | Refraction |
| | polarizer | | | | | |
| 4 | Reflective | −166.091 | 0.100 | 1.533 | 56.0 | Refraction |
| | polarizer | | | | | |
| 5 | Second lens | −166.091 | 2.500 | 1.544 | 55.9 | Refraction |
| 6 | | −234.82 | 8.955(Far point) | — | — | Refraction |
| | | | 6.072(Near point) | | | |
| 7 | First phase | Infinity | 0.100 | 1.544 | 55.9 | Refraction |
| | retarder | | | | | |
| 8 | Third lens | Infinity | 4.683 | 1.544 | 55.9 | Refraction |
| 9 | Partial- | −86.98 | 0.000 | Mirror | | Reflection |
| | reflective- | | | | | |
| | partial- | | | | | |
| | transmissive | | | | | |
| | element | | | | | |
| 10 | Third lens | −86.98 | −4.683 | 1.544 | 55.9 | Refraction |
| 11 | First phase | Infinity | −0.100 | 1.533 | 56.0 | Refraction |
| | retarder | | | | | |
| 12 | | Infinity | −8.955(Far point) | — | — | Refraction |
| | | | −6.072(Near point) | | | |
| 13 | Second lens | −234.82 | −2.500 | 1.544 | 55.9 | Refraction |
| 14 | Reflective | −166.091 | −0.100 | 1.533 | 56.0 | Refraction |
| 15 | polarizer | −166.091 | 0.100 | Mirror | | Reflection |
| 16 | Second lens | −166.091 | 2.500 | 1.544 | 55.9 | Refraction |
| 17 | | −234.82 | 8.955(Far point) | — | — | Refraction |
| | | | 6.072(Near point) | | | |
| 18 | First phase | Infinity | 0.100 | 1.533 | 56.0 | Refraction |
| | retarder | | | | | |
| 19 | Third lens | Infinity | 4.683 | 1.544 | 55.9 | Refraction |
| 20 | | −86.98 | 1.241 | — | — | Refraction |
| 21 | Second | Infinity | 0.100 | 1.533 | 56.0 | Refraction |
| | phase | | | | | |
| | retarder | | | | | |
| 22 | Image source | Infinity | — | — | — | — |
| | plane | | | | | |

The reference wavelength is 550 nm.

TABLE 22
Aspheric Coefficients

| Surface | 1 | 2 | 5, 14, 16 |
|---|---|---|---|
| K: | −5.5543E−01 | 7.3515E+01 | 0.0000E+00 |
| A2: | 0.0000E+00 | 0.0000E+00 | 0.0000E+00 |
| A4: | −2.5989E−05 | −3.2494E−05 | 0.0000E+00 |
| A6: | 1.3870E−08 | −2.6897E−08 | 0.0000E+00 |
| A8: | 1.9668E−10 | 3.7370E−10 | 0.0000E+00 |
| A10: | −2.4262E−12 | −2.2572E−12 | 0.0000E+00 |
| A12: | 5.2456E−15 | 3.1912E−15 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | −6.8160E+01 | 0.0000E+00 | −4.5279E+00 |
| A2: | 0.0000E+00 | 0.0000E+00 | 0.0000E+00 |
| A4: | 1.6834E−06 | 0.0000E+00 | 1.1700E−07 |
| A6: | −9.5517E−09 | 0.0000E+00 | 8.3290E−10 |
| A8: | 2.0729E−11 | 0.0000E+00 | 1.2994E−12 |
| A10: | −1.5455E−14 | 0.0000E+00 | −2.2227E−15 |
| A12: | 0.0000E+00 | 0.0000E+00 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 23

| | | | | | | | |
|---|---|---|---|---|---|---|---|
| f1 | 200.45 | T12_F | 0.52 | T23_N | 6.07 | CA1 | 15.73 |
| f2 | 439.87 | T12_N | 3.40 | CT3 | 4.68 | CA6 | 23.73 |
| f3 | 158.85 | CT2 | 2.50 | TL | 22.63 | TDP4 | 0.85 |
| CT1 | 4.33 | T23_F | 8.95 | IMH | 23.00 | TDP6 | 2.86 |

All units are mm (millimetre)

TABLE 24

| | | | | | |
|---|---|---|---|---|---|
| (FOV_F − FOV_N)/ | −0.62 | TDP4*CT2/ | 0.16 | R1*CT1/CA1 | 20.25 |
| (T12_F − T12_N) | | (TDP6*CT3) | | [mm] | |
| (f_F − f_N)/ | −0.08 | CA1/CA6 | 0.66 | R6/CA6 | −3.67 |
| (T23_F − T23_N) | | | | | |
| FOV_F/(TL*IMH) | 0.15 | (T12_F + T23_F)/ | 11.11 | f1/f3 | 1.26 |
| [°/mm\hat{ }2] | | TDP4 | | | |
| CT1/CT2 | 1.73 | TL/(CT1*CT3) | 1.12 | TL/IMH | 0.98 |
| | | [mm\hat{ }−1] | | | |
| CT3/CT2 | 1.87 | CT3*TDP6/CA6 | 0.56 | — | — |
| | | [mm] | | | |
| CA6/IMH | 1.03 | IMH/\| (f_F − f_N) \| | 105.44 | — | — |

### Eighth Embodiment

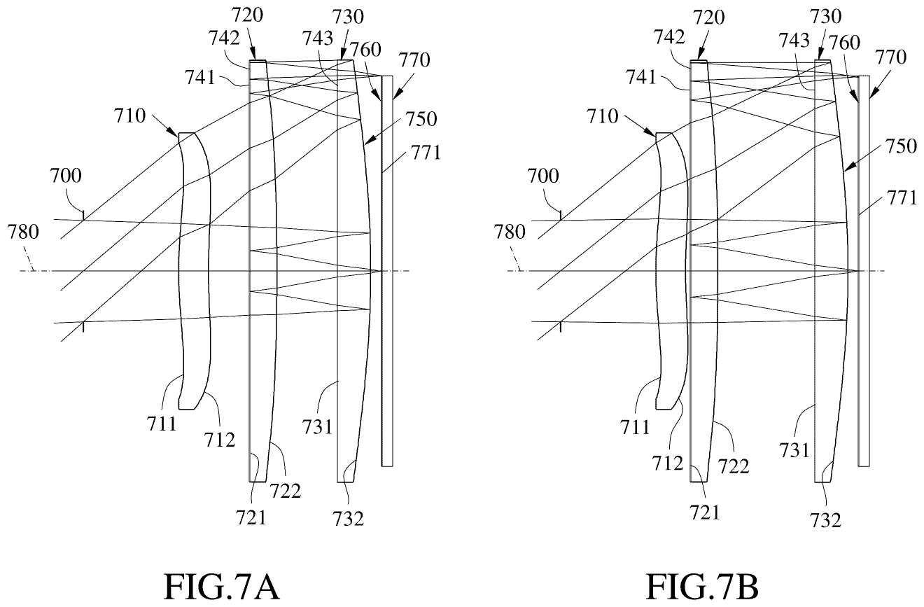

Referring to FIGS. 7A and 7B, an optical lens assembly in accordance with an eighth embodiment of the present invention includes, in order from a visual side to an image source side along an optical axis 780: a stop 700, a first lens 710, an absorptive polarizer 741, a reflective polarizer 742, a second lens 720, a first phase retarder 743, a third lens 730, a partial-reflective-partial-transmissive element 750, a second phase retarder 760 and an image source plane 771.

The optical lens assembly has, for example, but not limited to, a total of three lenses with refractive power. When the optical lens assembly focuses on a near point, the second lens 720 is closer to the third lens 730 but farther from the first lens 710; and when the optical lens assembly focuses on a far point, the second lens 720 is closer to the first lens 710 but farther from the third lens 730.

The configurations of the stop 700, the absorptive polarizer 741, the reflective polarizer 742, the first phase retarder 743, the partial-reflective-partial-transmissive element 750, the second phase retarder 760 and the image source plane 771 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 770 in cooperation with the optical lens assembly may refer to that of the second embodiment and will not be explained again.

The first lens 710 with positive refractive power includes a visual-side surface 711 and an image source-side 712, the visual-side surface 711 of the first lens 710 is convex in a paraxial region thereof, the image source-side surface 712 of the first lens 710 is concave in a paraxial region thereof, the visual-side surface 711 and the image source-side surface 712 of the first lens 710 are aspheric, and the first lens 710 is made of plastic.

The second lens 720 with positive refractive power includes a visual-side surface 721 and an image source-side surface 722, the visual-side surface 721 of the second lens 720 is flat in a paraxial region thereof, the image source-side surface 722 of the second lens 720 is convex in a paraxial region thereof, the image source-side surface 722 of the second lens 620 is aspheric, and the second lens 720 is made of plastic.

The third lens 730 with positive refractive power includes a visual-side surface 731 and an image source-side surface 732, the visual-side surface 731 of the third lens 730 is flat in a paraxial region thereof, the image source-side surface 732 of the third lens 730 is convex in a paraxial region thereof, the image source-side surface 732 of the third lens 730 is aspheric, and the third lens 730 is made of plastic.

Please refer to Tables 25-28, Table 25 shows the detailed optical data of the elements of the optical lens assembly of the eighth embodiment, Table 26 shows the aspheric coefficients of the aspherical surfaces of the elements of the optical lens assembly of the eighth embodiment, Table 27 shows the remaining parameters of the optical lens assembly of the eighth embodiment and the values thereof, and the values of the parameters in Tables 25 and 27 meet the conditional formulas of Table 28. In the eighth embodiment, the equation of the aspheric surface profiles of the aforementioned lenses is the same as the equation of the aspheric surface profiles of the aforementioned lenses in the second embodiment. The parameters and the definitions of the surfaces in Tables of the eighth embodiment are the same as those of Tables of the second embodiment and will not be explained again.

TABLE 25
f_F = 36.83 mm, f_N = 34.86 mm, EPD = 13.00 mm, FOV_F = 76.7°, FOV_N = 80.0°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 12.000 | — | — | — |
| 1 | First lens | 57.90 | 3.836 | 1.544 | 55.9 | Refraction |
| 2 | | 84.82 | 0.562(Far point) | — | — | Refraction |
| | | | 5.228(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 3.388 | 1.544 | 55.9 | Refraction |
| 6 | | −405.62 | 12.447(Far point) | — | — | Refraction |
| | | | 7.781(Near point) | | | |
| 7 | First phase | Infinity | 0.100 | 1.544 | 55.9 | Refraction |
| | retarder | | | | | |
| 8 | Third lens | Infinity | 4.203 | 1.544 | 55.9 | Refraction |
| 9 | Partial- | −128.62 | 0.000 | Mirror | | Reflection |
| | reflective- | | | | | |
| | partial- | | | | | |
| | transmissive | | | | | |
| | element | | | | | |
| 10 | Third lens | −128.62 | −4.203 | 1.544 | 55.9 | Refraction |
| 11 | First phase | Infinity | −0.100 | 1.533 | 56.0 | Refraction |
| | retarder | | | | | |
| 12 | | Infinity | −12.447(Far point) | — | — | Refraction |
| | | | −7.781(Near point) | | | |
| 13 | Second lens | −405.62 | −3.388 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 3.388 | 1.544 | 55.9 | Refraction |
| 17 | | −405.62 | 12.447(Far point) | — | — | Refraction |
| | | | 7.781(Near point) | | | |
| 18 | First phase | Infinity | 0.100 | 1.533 | 56.0 | Refraction |
| | retarder | | | | | |
| 19 | Third lens | Infinity | 4.203 | 1.544 | 55.9 | Refraction |
| 20 | | −128.62 | 1.283 | | | Refraction |
| 21 | Second | Infinity | 0.100 | 1.533 | 56.0 | Refraction |
| | phase | | | | | |
| | retarder | | | | | |
| 22 | Image | Infinity | — | — | — | — |
| | source | | | | | |
| | plane | | | | | |

The reference wavelength is 550 nm.

TABLE 26
Aspheric Coefficients

| Surface | 1 | 2 | 5, 14, 16 |
|---|---|---|---|
| K: | −1.3436E+01 | −3.1718E+01 | 0.0000E+00 |
| A2 | 0.0000E+00 | 0.0000E+00 | 0.0000E+00 |
| A4: | −2.4056E−05 | −2.8412E−05 | 0.0000E+00 |
| A6: | 4.4537E−08 | 2.6025E−08 | 0.0000E+00 |
| A8: | −3.3522E−10 | −1.9592E−10 | 0.0000E+00 |
| A10: | 7.3205E−13 | 3.2429E−13 | 0.0000E+00 |
| A12: | −8.7649E−16 | −4.7643E−16 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | 9.5305E+01 | 0.0000E+00 | −9.3384E+00 |
| A2 | 0.0000E+00 | 0.0000E+00 | 0.0000E+00 |
| A4 | −2.0156E−06 | 0.0000E+00 | 5.8916E−07 |
| A6: | 4.2047E−09 | 0.0000E+00 | −4.5125E−10 |
| A8: | −8.3151E−12 | 0.0000E+00 | 2.6080E−12 |
| A10: | 6.8107E−15 | 0.0000E+00 | −2.5043E−15 |
| A12: | 0.0000E+00 | 0.0000E+00 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 27

| | | | | | | | |
|---|---|---|---|---|---|---|---|
| f1 | 317.11 | T12_F | 0.56 | T23_N | 7.78 | CA1 | 16.39 |
| f2 | 740.50 | T12_N | 5.23 | CT3 | 4.20 | CA6 | 26.76 |
| f3 | 234.82 | CT2 | 3.39 | TL | 26.12 | TDP4 | 1.39 |
| CT1 | 3.84 | T23_F | 12.45 | IMH | 24.90 | TDP6 | 2.22 |

All units are mm (millimetre)

TABLE 28

| | | | | | |
|---|---|---|---|---|---|
| (FOV_F − FOV_N)/ | −0.71 | TDP4*CT2/ | 0.50 | R1*CT1/CA1 | 13.55 |
| (T12_F − T12_N) | | (TDP6*CT3) | | [mm] | |
| (f_F − f_N)/ | 0.42 | CA1/CA6 | 0.61 | R6/CA6 | −4.81 |
| (T23_F − T23_N) | | | | | |
| FOV_F/(TL*IMH) | 0.12 | (T12_F + T23_F)/TD | 9.37 | f1/f3 | 1.35 |
| [°/mm\hat{ }2] | | P4 | | | |
| CT1/CT2 | 1.13 | TL/(CT1*CT3) | 1.62 | TL/IMH | 1.05 |
| | | [mm\hat{ }−1] | | | |
| CT3/CT2 | 1.24 | CT3*TDP6/CA6 | 0.35 | — | — |
| | | [mm] | | | |
| CA6/IMH | 1.07 | IMH/\| (f_F − f_N) \| | 12.69 | — | — |

### Ninth Embodiment

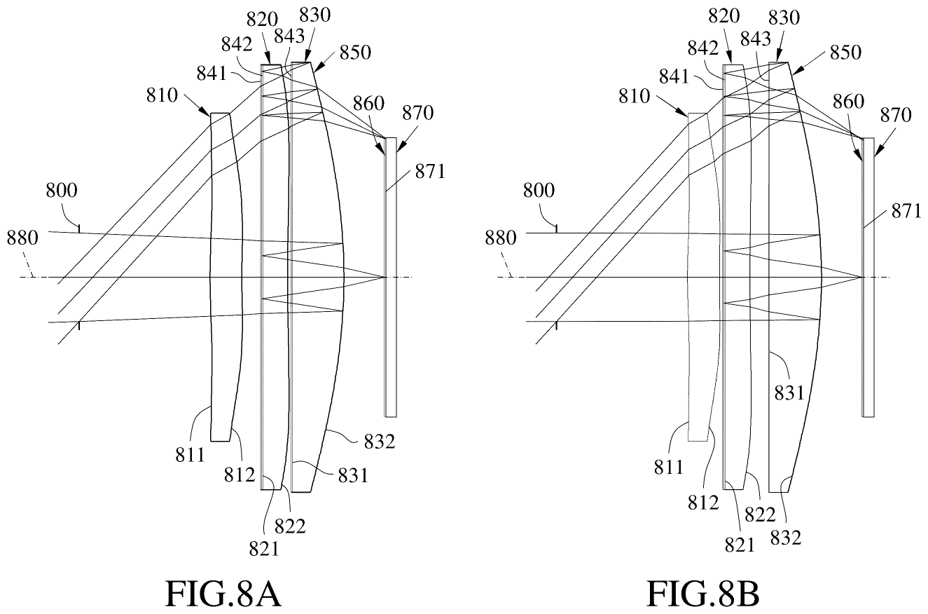

Referring to FIGS. 8A and 8B, an optical lens assembly in accordance with a ninth embodiment of the present invention includes, in order from a visual side to an image source side along an optical axis 880: a stop 800, a first lens 810, an absorptive polarizer 841, a reflective polarizer 842, a second lens 820, a first phase retarder 843, a third lens 830, a partial-reflective-partial-transmissive element 850, a second phase retarder 860 and an image source plane 871.

The optical lens assembly has, for example, but not limited to, a total of three lenses with refractive power. When the optical lens assembly focuses on a near point, the second lens 820 is closer to the third lens 830 but farther from the first lens 810; and when the optical lens assembly focuses on a far point, the second lens 820 is closer to the first lens 810 but farther from the third lens 830.

The configurations of the stop 800, the absorptive polarizer 841, the reflective polarizer 842, the first phase retarder 843, the partial-reflective-partial-transmissive element 850, the second phase retarder 860 and the image source plane 871 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 870 in cooperation with the optical lens assembly may refer to that of the second embodiment and will not be explained again.

The first lens 810 with positive refractive power includes a visual-side surface 811 and an image source-side 812, the visual-side surface 811 of the first lens 810 is convex in a paraxial region thereof, the image source-side surface 812 of the first lens 810 is concave in a paraxial region thereof, the visual-side surface 811 and the image source-side surface 812 of the first lens 810 are aspheric, and the first lens 810 is made of plastic.

The second lens 820 with negative refractive power includes a visual-side surface 821 and an image source-side surface 822, the visual-side surface 821 of the second lens 820 is flat in a paraxial region thereof, the image source-side surface 822 of the second lens 820 is concave in a paraxial region thereof, the image source-side surface 822 of the second lens 820 is aspheric, and the second lens 820 is made of plastic.

The third lens 830 with positive refractive power includes a visual-side surface 831 and an image source-side surface 832, the visual-side surface 831 of the third lens 830 is flat in a paraxial region thereof, the image source-side surface 832 of the third lens 830 is convex in a paraxial region thereof, the image source-side surface 832 of the third lens 830 is aspheric, and the third lens 830 is made of plastic.

Please refer to Tables 29-32, Table 29 shows the detailed optical data of the elements of the optical lens assembly of the ninth embodiment, Table 30 shows the aspheric coefficients of the aspherical surfaces of the elements of the optical lens assembly of the ninth embodiment, Table 31 shows the remaining parameters of the optical lens assembly of the ninth embodiment and the values thereof, and the values of the parameters in Tables 29 and 31 meet the conditional formulas of Table 32. In the ninth embodiment, the equation of the aspheric surface profiles of the aforementioned lenses is the same as the equation of the aspheric surface profiles of the aforementioned lenses in the second embodiment. The parameters and the definitions of the surfaces in Tables of the ninth embodiment are the same as those of Tables of the second embodiment and will not be explained again.

TABLE 29
f_F = 17.10 mm, f_N = 16.76 mm, EPD = 8.00 mm, FOV_F = 94.9°, FOV_N = 93.4°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 12.000 | — | — | |
| 1 | First lens | 63.47 | 2.923 | 1.544 | 55.9 | Refraction |
| 2 | | 113.38 | 0.300(Far point) | — | — | Refraction |
| | | | 1.701(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 2.278 | 1.544 | 55.9 | Refraction |
| 6 | | 252.80 | 1.701(Far point) | — | — | Refraction |
| | | | 0.300(Near point) | | | |
| 7 | First phase | Infinity | 0.100 | 1.544 | 55.9 | Refraction |
| | retarder | | | | | |
| 8 | Third lens | Infinity | 4.741 | 1.544 | 55.9 | Refraction |
| 9 | Partial- | −52.71 | 0.000 | Mirror | | Reflection |
| | reflective- | | | | | |
| | partial- | | | | | |
| | transmissive | | | | | |
| | element | | | | | |
| 10 | Third lens | −52.71 | −4.741 | 1.544 | 55.9 | Refraction |
| 11 | First phase | Infinity | −0.100 | 1.533 | 56.0 | Refraction |
| | retarder | | | | | |
| 12 | | Infinity | −1.701(Far point) | — | — | Refraction |
| | | | −0.300(Near point) | | | |
| 13 | Second lens | 252.80 | −2.278 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 2.278 | 1.544 | 55.9 | Refraction |
| 17 | | 252.80 | 1.059 | — | — | Refraction |
| 18 | First phase | Infinity | 0.100 | 1.533 | 56.0 | Refraction |
| | retarder | | | | | |
| 19 | Third lens | Infinity | 4.741 | 1.544 | 55.9 | Refraction |
| 20 | | −52.71 | 3.747 | — | — | Refraction |
| 21 | Second | Infinity | 0.100 | 1.533 | 56.0 | Refraction |
| | phase | | | | | |
| | retarder | | | | | |
| 22 | Image | Infinity | — | — | — | — |
| | source | | | | | |
| | plane | | | | | |

The reference wavelength is 550 nm.

TABLE 30
Aspheric Coefficients

| Surface | 1 | 2 | 5, 14, 16 |
|---|---|---|---|
| K: | 1.4213E+01 | 4.8354E+01 | 0.0000E+00 |
| A2: | 0.0000E+00 | 0.0000E+00 | 0.0000E+00 |
| A4: | −1.5513E−04 | −1.5901E−04 | 0.0000E+00 |
| A6: | 1.2951E−06 | 9.7254E−07 | 0.0000E+00 |
| A8: | −6.6035E−09 | −3.6851E−09 | 0.0000E+00 |
| A10: | 1.9640E−11 | 1.0547E−11 | 0.0000E+00 |
| A12: | −3.0159E−14 | −1.7516E−14 | 0.0000E+00 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | −9.9326E+00 | 0.0000E+00 | −2.0227E+00 |
| A2: | 0.0000E+00 | 0.0000E+00 | 0.0000E+00 |
| A4: | −6.6781E−06 | 0.0000E+00 | 2.8332E−06 |
| A6: | −1.2604E−08 | 0.0000E+00 | 7.9382E−09 |
| A8: | 6.0450E−11 | 0.0000E+00 | −7.8233E−11 |
| A10: | −3.5413E−13 | 0.0000E+00 | 2.7143E−13 |
| A12: | 5.9869E−16 | 0.0000E+00 | −3.0760E−16 |
| A14: | 0.0000E+00 | 0.0000E+00 | 0.0000E+00 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

TABLE 31

| | | | | | | | |
|---|---|---|---|---|---|---|---|
| f1 | 257.90 | T12_F | 0.30 | T23_N | 0.30 | CA1 | 13.90 |
| f2 | −461.51 | T12_N | 1.70 | CT3 | 4.74 | CA6 | 19.50 |
| f3 | 96.22 | CT2 | 2.28 | TL | 16.09 | TDP4 | 0.55 |
| CT1 | 2.92 | T23_F | 1.70 | IMH | 12.56 | TDP6 | 3.05 |

All units are mm (millimetre)

TABLE 32

| | | | | | |
|---|---|---|---|---|---|
| (FOV_F − FOV_N)/ | 1.07 | TDP4*CT2/ | 0.09 | R1*CT1/CA1 | 13.35 |
| (T12_F − T12_N) | | (TDP6*CT3) | | [mm] | |
| (f_F − f_N)/ | 0.24 | CA1/CA6 | 0.71 | R6/CA6 | −2.70 |
| (T23_F − T23_N) | | | | | |
| FOV_F/(TL*IMH) | 0.47 | (T12_F + T23_F)/ | 3.66 | f1/f3 | 2.68 |
| [°/mm\hat{ }2] | | TDP4 | | | |
| CT1/CT2 | 1.28 | TL/(CT1*CT3) | 1.16 | TL/IMH | 1.28 |
| | | [mm\hat{ }−1] | | | |
| CT3/CT2 | 2.08 | CT3*TDP6/CA6 | 0.74 | — | — |
| | | [mm] | | | |
| CA6/IMH | 1.55 | IMH/\| (f_F − f_N) \| | 37.76 | — | — |

### Tenth Embodiment

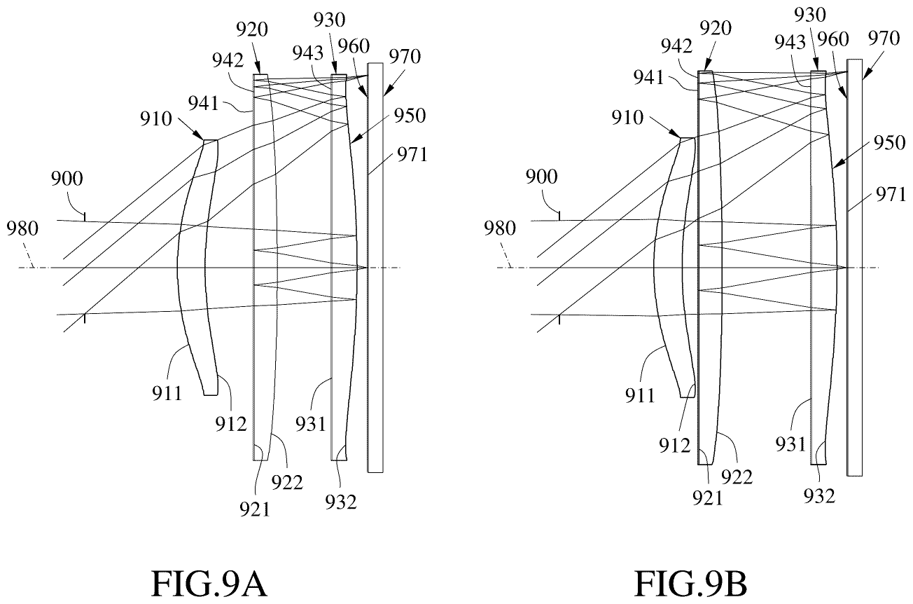

Referring to FIGS. 9A and 9B, an optical lens assembly in accordance with a tenth embodiment of the present invention includes, in order from a visual side to an image source side along an optical axis 980: a stop 900, a first lens 910, an absorptive polarizer 941, a reflective polarizer 942, a second lens 920, a first phase retarder 943, a third lens 930, a partial-reflective-partial-transmissive element 950, a second phase retarder 960 and an image source plane 971.

The optical lens assembly has, for example, but not limited to, a total of three lenses with refractive power. When the optical lens assembly focuses on a near point, the second lens 920 is closer to the third lens 930 but farther from the first lens 910; and when the optical lens assembly focuses on a far point, the second lens 920 is closer to the first lens 910 but farther from the third lens 930.

The configurations of the stop 900, the absorptive polarizer 941, the reflective polarizer 942, the first phase retarder 943, the partial-reflective-partial-transmissive element 950, the second phase retarder 960 and the image source plane 971 are the same as those of the stop 100, the absorptive polarizer 141, the reflective polarizer 142, the first phase retarder 143, the partial-reflective-partial-transmissive element 150, the second phase retarder 160 and the image source plane 171 of the second embodiment, and the configuration of an image source 970 in cooperation with the optical lens assembly may refer to that of the second embodiment and will not be explained again.

The first lens 910 with positive refractive power includes a visual-side surface 911 and an image source-side 912, the visual-side surface 911 of the first lens 910 is convex in a paraxial region thereof, the image source-side surface 912 of the first lens 910 is concave in a paraxial region thereof, the visual-side surface 911 and the image source-side surface 912 of the first lens 910 are aspheric, and the first lens 910 is made of plastic.

The second lens 920 with positive refractive power includes a visual-side surface 921 and an image source-side surface 922, the visual-side surface 921 of the second lens 920 is flat in a paraxial region thereof, the image source-side surface 922 of the second lens 920 is convex in a paraxial region thereof, the image source-side surface 922 of the second lens 920 is aspheric, and the second lens 920 is made of plastic.

The third lens 930 with positive refractive power includes a visual-side surface 931 and an image source-side surface 932, the visual-side surface 931 of the third lens 930 is flat in a paraxial region thereof, the image source-side surface 932 of the third lens 930 is convex in a paraxial region thereof, the image source-side surface 932 of the third lens 930 is aspheric, and the third lens 930 is made of plastic.

Please refer to Tables 33-36, Table 33 shows the detailed optical data of the elements of the optical lens assembly of the tenth embodiment, Table 34 shows the aspheric coefficients of the aspherical surfaces of the elements of the optical lens assembly of the tenth embodiment, Table 35 shows the remaining parameters of the optical lens assembly of the tenth embodiment and the values thereof, and the values of the parameters in Tables 33 and 35 meet the conditional formulas of Table 36. In the tenth embodiment, the equation of the aspheric surface profiles of the aforementioned lenses is the same as the equation of the aspheric surface profiles of the aforementioned lenses in the second embodiment. The parameters and the definitions of the surfaces in Tables of the tenth embodiment are the same as those of Tables of the second embodiment and will not be explained again.

TABLE 33
f_F = 35.13 mm, f_N = 33.47 mm, EPD = 8.00 mm, FOV_F = 76.9°, FOV_N = 79.5°

| Surface | | Reflective | Thickness/ | Refractive | Abbe | Refraction/ |
|---|---|---|---|---|---|---|
| # | | polarizer | gap | index (nd) | number (vd) | Reflection |
| 0 | Stop | Infinity | 12.000 | — | — | — |
| 1 | First lens | 31.56 | 3.597 | 1.544 | 55.9 | Refraction |
| 2 | | 47.06 | 1.955(Far point) | — | — | Refraction |
| | | | 6.184(Near point) | | | |
| 3 | Absorptive | Infinity | 0.100 | 1.533 | 56.0 | Refraction |
| | polarizer | | | | | |
| 4 | Reflective | Infinity | 0.100 | 1.533 | 56.0 | Refraction |
| | polarizer | | | | | |
| 5 | Second lens | Infinity | 2.944 | 1.544 | 55.9 | Refraction |
| 6 | | −436.55 | 11.242(Far point) | — | — | Refraction |
| | | | 7.0133(Near point) | | | |
| 7 | First phase | Infinity | 0.100 | 1.544 | 55.9 | Refraction |
| | retarder | | | | | |
| 8 | Third lens | Infinity | 3.255 | 1.544 | 55.9 | Refraction |
| 9 | Partial- | −128.37 | 0.000 | Mirror | | Reflection |
| | reflective- | | | | | |
| | partial- | | | | | |
| | transmissive | | | | | |
| | element | | | | | |
| 10 | Third lens | −128.37 | −3.255 | 1.544 | 55.9 | Refraction |
| 11 | First phase | Infinity | −0.100 | 1.533 | 56.0 | Refraction |
| | retarder | | | | | |
| 12 | | Infinity | −11.242(Far point) | — | — | Refraction |
| | | | −7.0133(Near point) | | | |
| 13 | Second lens | −436.55 | −2.944 | 1.544 | 55.9 | Refraction |
| 14 | Reflective | Infinity | −0.100 | 1.533 | 56.0 | Refraction |
| 15 | polarizer | Infinity | 0.100 | Mirror | | Reflection |
| 16 | Second lens | Infinity | 2.944 | 1.544 | 55.9 | Refraction |
| 17 | | −436.55 | 11.242(Far point) | — | — | Refraction |
| | | | 7.0133(Near point) | | | |
| 18 | First phase | Infinity | 0.100 | 1.533 | 56.0 | Refraction |
| | retarder | | | | | |
| 19 | Third lens | Infinity | 3.255 | 1.544 | 55.9 | Refraction |
| 20 | | −128.37 | 1.315 | — | — | Refraction |
| 21 | Second | Infinity | 0.100 | 1.533 | 56.0 | Refraction |
| | phase | | | | | |
| | retarder | | | | | |
| 22 | Image | Infinity | — | — | — | — |
| | source | | | | | |
| | plane | | | | | |

The reference wavelength is 550 nm.

TABLE 34
Aspheric Coefficients

| Surface | 1 | 2 | 5, 14, 16 |
|---|---|---|---|
| K: | 7.0065E−01 | 1.1542E+00 | 0.0000E+00 |
| A2: | 0.0000E+00 | 0.0000E+00 | 0.0000E+00 |
| A4: | −1.4345E−05 | −1.4550E−05 | 0.0000E+00 |
| A6: | 5.4269E−10 | 2.7548E−09 | 0.0000E+00 |
| A8: | 6.7661E−11 | 5.1233E−11 | 0.0000E+00 |
| A10: | −8.8748E−13 | −8.3640E−13 | 0.0000E+00 |
| A12: | 1.7851E−15 | 1.6227E−15 | 0.0000E+00 |
| A14: | 4.5587E−18 | 4.8199E−18 | 0.0000E+00 |
| A16: | −2.6738E−20 | −2.4764E−20 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 13, 17 | 8, 11, 19 | 9, 20 |
|---|---|---|---|
| K: | 5.8772E+01 | 0.0000E+00 | −1.1897E+01 |
| A2: | 0.0000E+00 | 0.0000E+00 | 0.0000E+00 |
| A4: | −1.3575E−06 | 0.0000E+00 | 6.0501E−07 |
| A6: | −3.8179E−11 | 0.0000E+00 | −6.2308E−10 |
| A8: | 1.4126E−11 | 0.0000E+00 | 6.4595E−12 |
| A10: | −4.1264E−14 | 0.0000E+00 | −1.4028E−14 |
| A12: | 3.4148E−17 | 0.0000E+00 | 2.6123E−17 |
| A14: | −1.2048E−21 | 0.0000E+00 | −2.5067E−20 |
| A16: | −6.8225E−24 | 0.0000E+00 | 2.3175E−23 |
| A18: | 0.0000E+00 | 0.0000E+00 | 0.0000E+00 |
| A20: | 0.0000E+00 | 0.0000E+00 | 0.0000E+00 |

TABLE 35

| | | | | | | | |
|---|---|---|---|---|---|---|---|
| f1 | 161.32 | T12_F | 1.95 | T23_N | 7.01 | CA1 | 15.97 |
| f2 | 795.44 | T12_N | 6.18 | CT3 | 3.25 | CA6 | 24.75 |
| f3 | 233.90 | CT2 | 2.94 | TL | 24.70 | TDP4 | 1.19 |
| CT1 | 3.60 | T23_F | 11.24 | IMH | 24.90 | TDP6 | 1.37 |

All units are mm (millimetre)

TABLE 36

| | | | | | |
|---|---|---|---|---|---|
| (FOV_F − FOV_N)/ | −0.61 | TDP4*CT2/ | 0.78 | R1*CT1/CA1 | 7.11 |
| (T12_F − T12_N) | | TDP6*CT3) | | [mm] | |
| (f_F−f_N)/ | 0.39 | CA1/CA6 | 0.65 | R6/CA6 | −5.19 |
| (T23_F − T23_N) | | | | | |
| FOV_F/(TL*IMH) | 0.13 | (T12_F + T23_F)/ | 11.13 | f1/f3 | 0.69 |
| [°/mm\hat{ }2] | | TDP4 | | | |
| CT1/CT2 | 1.22 | TL/(CT1*CT3) | 2.11 | TL/IMH | 0.99 |
| | | [mm\hat{ }−1] | | | |
| CT3/CT2 | 1.11 | CT3*TDP6/CA6 | 0.18 | — | — |
| | | [mm] | | | |
| CA6/IMH | 0.99 | IMH/\| (f_F − f_N) \| | 15.01 | — | — |

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly.

For the optical lens assembly in the present invention, the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

For the optical lens assembly in the present invention, the maximum effective radius of the lens surface is usually a radius of the effective optical region of the lens surface (i.e., a region which is not subjected to any surface treatment or extinction processing or is not provided with any shade).

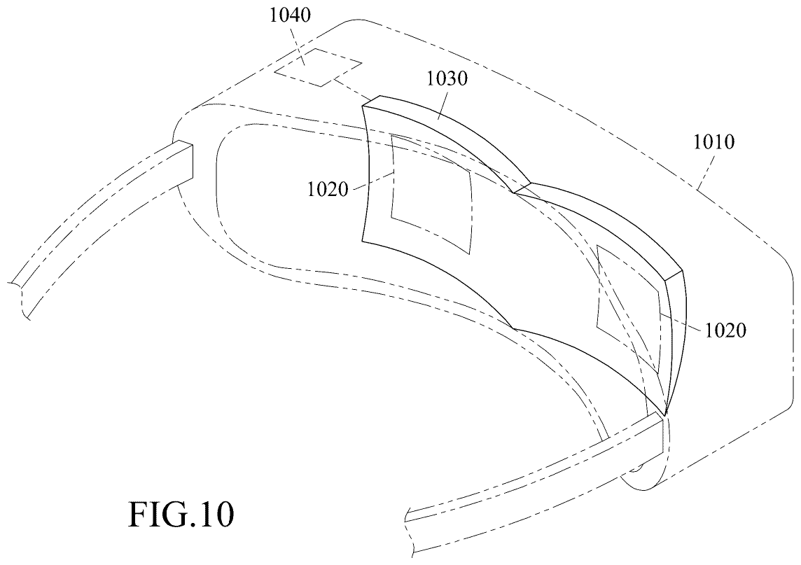

The optical lens assembly of the present invention can be used in an electronic device, for example, but not limited to a head-mounted electronic device. The head-mounted electronic device, for example, but not limited to a head-mounted display device. FIG. 10 shows a head-mounted display device in accordance with an embodiment of the present invention. The head-mounted display device using, but is not limited to, the virtual reality technology or mixed reality technology and includes a housing 1010 and an optical module 1020, an image source 1030 and a controller 1040 disposed in the housing 1010.

The optical module 1020 corresponds to the left and right eyes of the user. The optical module 1020 includes an optical lens assembly described in any one of the first to sixth embodiments.

The image source 1030 can be an image source described in any one of the first to sixth embodiments. The image source 1030 corresponds to the left and right eyes of the user, and the type of the image source 1030 may be an OLED display, a LED display, a liquid crystal display, or other display, but is not limited thereto.

The controller 1040 is electrically connected to the image source 1030, so as to control the image source 1030 to display an image, whereby the head-mounted display device can project the image to the eyes of the user.

What is claimed is:

1. An optical lens assembly comprising:
a first lens with positive refractive power, including a visual-side surface being convex in a paraxial region thereof;
a reflective polarizer;
a second lens with refractive power;
a phase retarder;
a third lens with positive refractive power, including an image source-side surface being convex in a paraxial region thereof; and
a partial-reflective-partial-transmissive element;
wherein the first lens, the reflective polarizer, the second lens, the third lens and the partial-reflective-partial-transmissive element are disposed in order from a visual side to an image source side, and the phase retarder is disposed between the reflective polarizer and the partial-reflective-partial-transmissive element; and
a thickness of the second lens along an optical axis is CT2, a thickness of the third lens along the optical axis is CT3, an absolute value of a displacement in parallel to the optical axis from an intersection between an image source-side surface of the second lens and the optical axis to a maximum effective radius position on the image source-side surface of the second lens is TDP4, an absolute value of a displacement in parallel to the optical axis from an intersection between the image source-side surface of the third lens and the optical axis to a maximum effective radius position on the image source-side surface of the third lens is TDP6, and the following conditional formula is satisfied: 0.05<TDP4*CT2/(TDP6*CT3)<1.35.

2. The optical lens assembly as claimed in claim 1, wherein a maximum field of view of the optical lens assembly focusing on a far point is FOV_F, a maximum field of view of the optical lens assembly focusing on a near point is FOV_N, a distance from an image source-side surface of the first lens to a visual-side surface of the second lens along the optical axis, when the optical lens assembly focuses on the far point, is T12_F, a distance from an image source-side surface of the first lens to the visual-side surface of the second lens along the optical axis, when the optical lens assembly focuses on the near point is, T12_N, and the following conditional formula is satisfied: −0.86<(FOV_F−FOV_N)/(T12_F−T12_N)<5.33.

3. The optical lens assembly as claimed in claim 1, wherein a focal length of the optical lens assembly focusing on a far point is f_F, a focal length of the optical lens assembly focusing on a near point is f_N, a distance from the image source-side surface of the second lens to a visual-side surface of the third lens along the optical axis, when the optical lens assembly focuses on the far point, is T23_F, a distance from the image source-side surface of the second lens to the visual-side surface of the third lens along the optical axis, when the optical lens assembly focuses on the near point, is T23_N, and the following conditional formula is satisfied: −0.09<(f_F−f_N)/(T23_F−T23_N)<0.59.

4. The optical lens assembly as claimed in claim 1, wherein a maximum field of view of the optical lens assembly focusing on a far point is FOV_F, a distance from the visual-side surface of the first lens to an image plane along the optical axis is TL, a maximum image height of the optical lens assembly is IMH, and the following conditional formula is satisfied: 0.09<FOV_F/(TL*IMH)<0.63.

5. The optical lens assembly as claimed in claim 1, wherein a thickness of the first lens along the optical axis is CT1, the thickness of the second lens along the optical axis is CT2, and the following conditional formula is satisfied: 0.54<CT1/CT2<3.11.

6. The optical lens assembly as claimed in claim 1, wherein the thickness of the second lens along the optical axis is CT2, the thickness of the third lens along the optical axis is CT3, and the following conditional formula is satisfied: 0.61<CT3/CT2<4.19.

7. The optical lens assembly as claimed in claim 1, wherein a maximum effective radius of the image source-side surface of the third lens is CA6, a maximum image height of the optical lens assembly is IMH, and the following conditional formula is satisfied: 0.8<CA6/IMH<1.95.

8. The optical lens assembly as claimed in claim 1, wherein a maximum effective radius of the visual-side surface of the first lens is CA1, a maximum effective radius of the image source-side surface of the third lens is CA6, and the following conditional formula is satisfied: 0.48<CA1/CA6<0.91.

9. The optical lens assembly as claimed in claim 1, wherein a distance from an image source-side surface of the first lens to a visual-side surface of the second lens along the optical axis, when the optical lens assembly focuses on a far point, is T12_F, a distance from the image source-side surface of the second lens to a visual-side surface of the third lens along the optical axis, when the optical lens assembly focuses on the far point, is T23_F, the absolute value of the displacement in parallel to the optical axis from the intersection between the image source-side surface of the second lens and the optical axis to the maximum effective radius position on the image source-side surface of the second lens is TDP4, and the following conditional formula is satisfied: 0.52<(T12_F+T23_F)/TDP4<54.9.

10. The optical lens assembly as claimed in claim 1, wherein a distance from the visual-side surface of the first lens to an image plane along the optical axis is TL, a thickness of the first lens along the optical axis is CT1, the thickness of the third lens along the optical axis is CT3, and the following conditional formula is satisfied: 0.4 mm⁻¹<TL/(CT1*CT3)<2.73 mm⁻¹.

11. The optical lens assembly as claimed in claim 1, wherein the thickness of the third lens along the optical axis is CT3, the absolute value of the displacement in parallel to the optical axis from the intersection between the image source-side surface of the third lens and the optical axis to the maximum effective radius position on the image source-side surface of the third lens is TDP6, a maximum effective radius of the image source-side surface of the third lens is CA6, and the following conditional formula is satisfied: 0.14 mm<CT3*TDP6/CA6<1.42 mm.

12. The optical lens assembly as claimed in claim 1, wherein a maximum image height of the optical lens assembly is IMH, a focal length of the optical lens assembly focusing on a far point is f_F, a focal length of the optical lens assembly focusing on a near point is f_N, and the following conditional formula is satisfied: 10.16<IMH/|(f_F−f_N)|<126.53.

13. The optical lens assembly as claimed in claim 1, wherein a radius of curvature of the visual-side surface of the first lens is R1, a thickness of the first lens along the optical axis is CT1, a maximum effective radius of the visual-side surface of the first lens is CA1, and the following conditional formula is satisfied: 5.46<R1*CT1/CA1<35.19.

14. The optical lens assembly as claimed in claim 1, wherein a radius of curvature of the image source-side surface of the third lens is R6, a maximum effective radius of the image source-side surface of the third lens is CA6, and the following conditional formula is satisfied: −6.57<R6/CA6<−2.16.

15. The optical lens assembly as claimed in claim 1, wherein a focal length of the first lens is f1, a focal length of the third lens is f3, and the following conditional formula is satisfied: 0.55<f1/f3<9.61.

16. The optical lens assembly as claimed in claim 1, wherein a distance from the visual-side surface of the first lens to an image plane along the optical axis is TL, a maximum image height of the optical lens assembly is IMH, and the following conditional formula is satisfied: 0.79<TL/IMH<1.55

17. The optical lens assembly as claimed in claim 1, wherein at least one of an object-side surfaces of the second lens and an object-side surface of the third lens is flat in a paraxial region thereof.

18. The optical lens assembly as claimed in claim 1, wherein a total number of lenses with refractive power is three in the optical lens assembly.

19. The optical lens assembly as claimed in claim 1, wherein when the optical lens assembly focuses on a near point, the second lens is closer to the third lens but farther from the first lens; and when the optical lens assembly focuses on a far point, the second lens is closer to the first lens but farther from the third lens.

20. An electronic device, comprising:
a housing;
an optical lens assembly as claimed in claim 1, disposed in the housing;
an image source disposed on an image source plane of the optical lens assembly in the housing; and
a controller disposed in the housing and electrically connected to the image source.
